(19) United States
(12) Patent Application Publication
(10) Pub. No.: US 2026/0107239 A1
(43) Pub. Date: Apr. 16, 2026

(54) ANTENNA LOAD MISMATCH CALIBRATION FOR RADIO FREQUENCY (RF) TRANSMITTERS, AND RELATED APPARATUSES AND METHODS

(71) Applicant: Microchip Technology Incorporated, Chandler, AZ (US)

(72) Inventors: Siavash Sheikh Zeinoddin, Calgary (CA); Amir Dezfooliyan, Yorba Linda, CA (US); Pansop Kim, Torrance, CA (US)

(21) Appl. No.: 19/357,202

(22) Filed: Oct. 14, 2025

Related U.S. Application Data
(60) Provisional application No. 63/707,541, filed on Oct. 15, 2024.

(51) Int. Cl. H04W 52/36; H04W 24/08; H04W 52/02

(52) U.S. Cl. CPC H04W 52/367; H04W 24/08; H04W 52/0245

(57) ABSTRACT

A method is executed at one or more processors adapted to control and monitor transmit output power of RF signals transmitted through an RF transmitter front-end based on one or more stored mappings of calibrated values. The one or more stored mappings include a reference gain index and a reference output power value associated with the reference gain index. The method includes executing a post-calibration process with respect to an antenna having a mismatched impedance. The post-calibration process includes determining a new reference gain index associated with the mismatched impedance based on a reference gain index difference that satisfies a reference output power mismatch loss at the reference gain index; measuring new transmit signal strength indicator (TSSI) values at new gain indexes adjusted based on the new reference gain index; and updating the one or more stored mappings to include the new reference gain index and the new TSSI values.

### CROSS-REFERENCE TO RELATED APPLICATIONS

This application claims the benefit under 35 U.S.C. § 119(e) of U.S. Provisional Patent Application Ser. No. 63/707,541, filed Oct. 15, 2024, the disclosure of which is hereby incorporated herein in its entirety by this reference.

### TECHNICAL FIELD

Examples relate, generally, to radio frequency (RF) telecommunications, and more particularly to antenna load mismatch calibration for RF transmitters. In addition, related apparatuses and methods are disclosed.

### BACKGROUND

Calibration of a radio frequency (RF) transmitter is performed to ensure efficient RF signal transmission by compensating for various RF impairments. RF calibration may be performed in the factory using a conducted configuration, typically a 50 ohm termination. In actual application, when an antenna load differs significantly from the conducted configuration, RF transmission performance may exhibit different behaviors than expected, making the factory RF calibration no longer applicable. If not mitigated, the RF transmission may exhibit performance degradation and/or be inconsistent with Federal Communications Commission (FCC) requirements.

### BRIEF DESCRIPTION OF THE DRAWINGS

While this disclosure concludes with claims particularly pointing out and distinctly claiming specific examples, various features and advantages of examples within the scope of this disclosure may be more readily ascertained from the following description when read in conjunction with the accompanying drawings, in which:

FIG. 1 is a schematic block diagram of an apparatus comprising a radio frequency (RF) signal transmitting apparatus of an RF transmitter that is known by the inventors of this disclosure;

FIG. 2A is a flowchart of a method of one or more calibration processes of the RF signal transmitting apparatus of FIG. 1;

FIG. 2B is a flowchart of a method of one or more calibration processes of the RF signal transmitting apparatus of FIG. 1;

FIG. 3 is a three-dimensional plot of calibrated values for the RF signal transmitting apparatus of FIG. 1;

FIG. 4A is a schematic block diagram of the RF signal transmitting apparatus of FIG. 1 for observation of load conditions;

FIG. 4B is a schematic diagram portion of the RF signal transmitting apparatus of FIG. 4A, with a top portion representing a matched load condition and a bottom portion representing a mismatched load condition;

FIG. 5 is a schematic block diagram of an apparatus comprising an RF signal transmitting apparatus of an RF transmitter, according to one or more examples of the disclosure;

FIG. 6 is a flowchart of a method of a post-calibration procedure for the RF signal transmitting apparatus of FIG. 5, according to one or more examples;

FIG. 7 is a Smith chart used to characterize an antenna for the RF signal transmitting apparatus of FIG. 5, according to one or more examples;

FIGS. 8A and 8B form a flowchart of a method of processing to operate an RF signal transmitting apparatus, which includes a post-calibration process, according to one or more examples of the disclosure;

FIG. 9 is a three-dimensional plot of calibrated values for the RF signal transmitting apparatus, according to one or more examples;

FIG. 10 is a two-dimensional plot of transmit signal strength indicator (TSSI) versus RF gain of a Gain-TSSI (GT) plane, which is based on the GT plane of the plot of FIG. 9, according to one or more examples;

FIG. 11 is a two-dimensional plot of output power versus RF gain of a Gain-Power (GP) plane, which is based on the GP plane of the plot of FIG. 9, according to one or more examples;

FIG. 12A is a plot of the output power versus RF gain from the GP plane of FIG. 11, further indicating a target mismatched impedance GP curve associated with a target mismatched impedance Gain-to-Power relationship in the GP plane, according to one or more examples;

FIG. 12B is a close-up view of the plot of FIG. 12A, further indicating the reference gain index difference associated with the predetermined impedance and a reference gain index difference associated with the mismatched impedance;

FIG. 13 is a plot of an amplitude modulation to amplitude modulation (AM-AM) curve for an RF power amplifier (RF) which includes two mismatched load profiles, according to one or more examples;

FIG. 14 is a flowchart of a method of processing to operate an RF signal transmitting apparatus, which includes a post-calibration process for a digital pre-distortion (DPD) profile correction, according to one or more examples of the disclosure;

FIG. 15 is a plot including a curve of amplitude (output power) versus RF gain (or gain index) for the RF PA, according to one or more examples;

FIG. 16A is a plot of example measurements of output power and EVM versus load phase for RF transmission, with an antenna voltage standing wave ratio (VSWR) of two (2), without use of a post-calibration process of the disclosure;

FIG. 16B is a graph of example measurements of output power and EVM versus load phase for RF transmission, with the antenna VSWR of two (2), with use of the post-calibration process of the disclosure;

FIG. 17 is a flowchart of a method of processing to operate an RF signal transmitting apparatus, which includes a post-calibration process, according to one or more examples of the disclosure; and

FIG. 18 is a block diagram of circuitry that, in some examples, may be used to implement various functions, operations, acts, processes, and/or methods disclosed herein.

### DETAILED DESCRIPTION

In the following detailed description, reference is made to the accompanying drawings, which form a part hereof, and in which are shown, by way of illustration, specific examples in which the present disclosure may be practiced. These examples are described in sufficient detail to enable a person of ordinary skill in the art to practice the present disclosure. However, other examples enabled herein may be utilized, and structural, material, and process changes may be made without departing from the scope of the disclosure.

The illustrations presented herein are not meant to be actual views of any particular method, system, device, or structure, but are merely idealized representations that are employed to describe the examples of the present disclosure. In some instances, similar structures or components in the various drawings may retain the same or similar numbering for the convenience of the reader; however, the similarity in numbering does not necessarily mean that the structures or components are identical in size, composition, configuration, or any other property.

The following description may include examples to help enable one of ordinary skill in the art to practice the disclosed examples. The use of the terms “exemplary,” “by example,” and “for example,” means that the related description is explanatory, and though the scope of the disclosure is intended to encompass the examples and legal equivalents, the use of such terms is not intended to limit the scope of an examples or this disclosure to the specified components, steps, features, functions, or the like.

It will be readily understood that the components of the examples as generally described herein and illustrated in the drawings could be arranged and designed in a wide variety of different configurations. Thus, the following description of various examples is not intended to limit the scope of the present disclosure, but is merely representative of various examples. While the various aspects of the examples may be presented in the drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be shown in block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art will understand that information and signals may be represented using any of a variety of different technologies and techniques. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal.

The various illustrative logical blocks, modules, and circuits described in connection with the examples disclosed herein may be implemented or performed with a general purpose processor, a special purpose processor, a microcontroller unit (MCU), a digital signal processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is to execute computing instructions (e.g., software code) related to examples of the present disclosure.

The examples may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, a subprogram, other structure, or combinations thereof. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Thus, a reference to first and second elements does not mean that only two elements may be employed there or that the first element must precede the second element in some manner. In addition, unless stated otherwise, a set of elements may include one or more elements.

As used herein, the term “substantially” in reference to a given parameter, property, or condition means and includes to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Calibration of an RF transmitter is performed to ensure efficient RF signal transmission by compensating for various RF impairments. RF calibration may be performed in the factory using a conducted configuration, typically a 50 ohm termination. If a user selects an antenna that does not meet recommended load specifications, the factory calibration settings associated with the conducted configuration are no longer applicable.

When the antenna load differs significantly from the conducted configuration, RF transmission performance may exhibit different behaviors than expected. If the antenna load mismatch is not compensated, the RF transmission may exhibit performance degradation and/or be inconsistent with specifications and/or Federal Communications Commission (FCC) requirements. Performance degradation may include inefficient power transfer, reduced signal propagation, and/or power fluctuation. Performance degradation can significantly degrade signal quality and increase error vector magnitude (EVM), which indicates the quality of a digitally-modulated signal (e.g., a measurement of the difference between ideal constellation points and actual measured points).

According to one or more examples of the disclosure, a post-calibration process has been developed to solve a problem where a user selects a mismatched antenna for use with an RF signal transmitting apparatus. In one or more examples, the post-calibration process is adapted to adjust factory calibration settings to provide stable radiated operation for the RF signal transmitting apparatus via the mismatched antenna. Such post-calibration process is a new approach that has not been known nor reported in the industry.

When an RF signal transmitting apparatus is made available on the market, and a user connects an antenna having a mismatched impedance, it is difficult to accurately measure the actual RF transmission performance for the purpose of correcting a mismatch loss. In one or more examples of the disclosure, a post-calibration process is used to adjust stored calibration values for correcting mismatch loss in a manner that does not necessitate the evaluation of RF transmission performance “over-the-air” and/or with use of external test measurement equipment. In one or more examples, the post-calibration process is a simple, user-friendly, and fast user-invoked post-calibration process that provides, without the need for external equipment, a stable transmit output power and an acceptable EVM, thereby providing adequate or even mostly perfect (at least in many instances) RF signal transmission.

In one or more examples, the post-calibration process is adapted to adjust calibration settings based on a reference gain index difference that satisfies a reference output power mismatch loss at a reference gain index (e.g., a reference gain index that corresponds to a target or reference output power under the matched load). For example, a difference in transmit signal strength indicator (TSSI) measurements between matched and unmatched load conditions may be used to determine new RF gain settings to load power. Measurements of new TSSI values associated with these new RF gain settings may be made under the new load conditions. The new RF gain settings may then correspond to the correct output power settings, and the new TSSI values may then correspond to the correct output power readings. In this exemplary manner, RF transmission performance may be restored such that the RF signal transmitting apparatus meets specifications and FCC requirements using the mismatched antenna.

In one or more examples, the post-calibration process may include a post-DPD calibration process using the mismatched antenna for digital pre-distortion (DPD) correction. Here, a power backoff used for control of the transmit output power may be determined based on a difference in DPD gain values between matched and unmatched load conditions. Again, with the two post-calibration process adjustments, adequate or even mostly perfect (at least in many instances) RF signal transmission can be assured.

In one or more examples, the post-calibration process may broaden the antenna selection pool for the user by allowing an adjustment of calibration settings to maintain adequate RF transmission performance. For example, the post-calibration process may be utilized for a variety of antennas associated with a voltage standing wave ratio (VSWR) of between about 1.5 and 3. The post-calibration process may reduce the cost that would otherwise be incurred using full recalibrations for each specific mismatched antenna impedance. In one or more other examples, the post-calibration process may reduce factory validation costs for new designs where significant effort would otherwise be put into impedance matching correlation to a particular load. With the post-calibration process, factory calibration processes may rely upon a wider tolerance to thereby reduce the efforts.

According to one or more examples of the disclosure, an RF signal transmitting apparatus includes one or more processors adapted to control and monitor transmit output power of RF signals transmitted from an RF transmitter front-end at least partially based on one or more stored mappings of calibrated values stored in memory. The one or more stored mappings of calibrated values are associated with RF transmission from the RF transmitter front-end at least initially with respect to a load having a predetermined impedance. The one or more stored mappings are at least between gain indexes, TSSI values, and output power values, and include a reference gain index and a reference output power value associated with the reference gain index.

The one or more processors are to execute a post-calibration process for the RF transmitter front-end with respect to an antenna having a mismatched impedance different from the predetermined impedance. The post-calibration process is to determine a new reference gain index associated with the mismatched impedance at least partially based on a reference gain index difference that satisfies a reference output power mismatch loss at the reference gain index; measure new TSSI values at respective new gain indexes adjusted at least partially based on the new reference gain index; and update the one or more stored mappings to include the new reference gain index and the new TSSI values for association with the output power values.

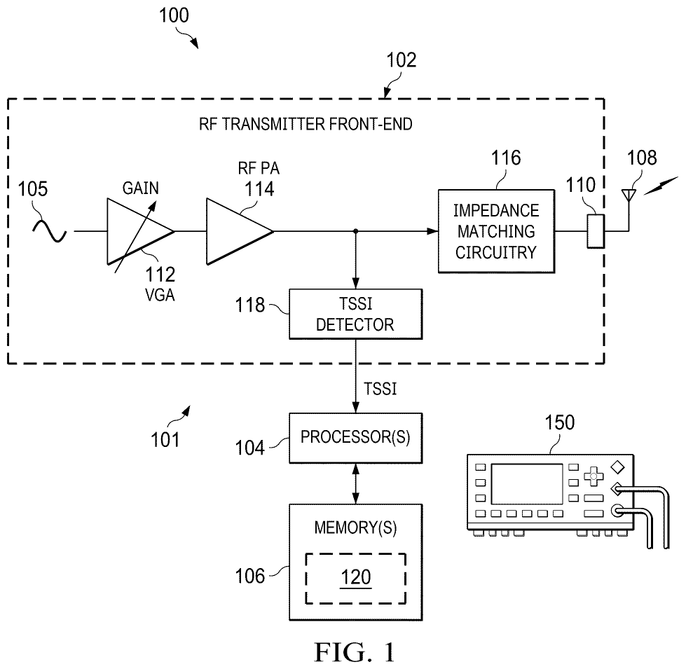

FIG. 1 is a schematic block diagram of an apparatus 100 comprising an RF signal transmitting apparatus 101 of an RF transmitter that is known by the inventors of this disclosure. RF signal transmitting apparatus 101 includes one or more processors 104, memory 106, and an RF transmitter front-end 102. RF transmitter front-end 102 includes a variable gain amplifier (VGA) 112, a RF power amplifier (PA) 114, impedance matching circuitry 116, and a TSSI detector 118, coupled in the arrangement shown in FIG. 1. An antenna 108 may be coupled to an antenna port 110 of, or signal output from, RF transmitter front-end 102.

In one or more examples, at least a substantial portion of RF signal transmitting apparatus 101 is included in an IC. For example, at least substantial portions of RF signal transmitting apparatus 101 may be included in an ASIC and an MCU, and/or a system-on-chip (SoC) including the ASIC and the MCU.

In a contemplated operation, a modulated RF signal 105 is passed to VGA 112, the gain of which is (e.g., dynamically) controlled to achieve a precise, controlled signal amplitude. This relatively low-power RF signal is passed from VGA 112 to RF PA 114 which boosts or amplifies the RF signal. The amplified RF signal is output from RF PA 114 to antenna 108 through impedance matching circuitry 116. Antenna 108, which is connected to antenna port 110, converts the electrical signal into electromagnetic waves for RF signal transmission.

One or more processors 104 are adapted to control and monitor a transmit output power of the amplified RF signals transmitted through RF transmitter front-end 102. TSSI detector 118, which is coupled to the output of RF PA 114, measures and provides an indication of the transmit output power to one or more processors 104. More specifically, TSSI detector 118 measures an output voltage of the amplified RF signal to provide a proportional indicator of the transmit output power.

In one or more examples, the output of TSSI detector 118 may provide a direct current (DC) voltage, which is input to an analog-to-digital converter (ADC) of one or more processors 104. One or more processors 104 may interpret the digitally-converted signal voltage for monitoring and adjusting the transmit output power (e.g., to ensure the transmitted RF signal remains within desired limits). In one or more examples, TSSI detector 118 is or includes a peak detector. The peak detector may capture the “peak” or highest voltages of the amplified RF signal, where such voltages are used to monitor and control the transmit power level.

It is generally desirable to optimize the transfer of output power from RF transmitter front-end 102 to antenna 108. The characteristics of RF blocks, such as those including RF PA 114, vary depending on the load impedance. Impedance matching circuitry 116 includes components, such as inductors and capacitors, having component values that are selected to adjust an impedance of the path from RF transmitter front-end 102 to antenna 108. In particular, the values of the components of impedance matching circuitry 116 are selected in advance to match an expected, suggested, or predetermined impedance of the load (e.g., as an “output matching network”). Load impedance matching optimizes the transfer of output power and prevents power reflections that would otherwise reduce RF transmission efficiency. In one or more examples, the expected, suggested, or predetermined load impedance is chosen to be about 50 ohms (Ω).

Prior to real-world use, RF signal transmitting apparatus 101 including RF transmitter front-end 102 may be calibrated. Calibration is typically used to refine operation and optimize performance of electronic circuitry. Calibration is also typically used to compensate for performance characteristics that vary due to a number of different factors (e.g., environmental factors, manufacturing process variations, component aging, and so on), variations that could otherwise lead to reduced efficiency in operation.

To more precisely control and monitor the transmit output power of RF transmitter front-end 102, one or more calibration processes are executed to generate and store one or more mappings of calibrated values for RF signal transmission (e.g., one or more stored mappings 120 in memory 106). In one or more examples, the one or more stored mappings include relationships or associations between gain indexes, TSSI values, and output power values associated with RF signal transmission with respect to a load having the predetermined load impedance (e.g., about 50 ohms or “50Ω”). In operation, the RF gain of RF transmitter front-end 102 may be adjusted at least partially through VGA 112 using gain indexes. In one or more examples, the calibrated values in one or more stored mappings 120 may be accessed by one or more processors 104 to apply to VGA 112 and/or RF PA 114 for control thereof, and/or accessed directly by processing circuitry for VGA 112 and/or RF PA 114 for control thereof.

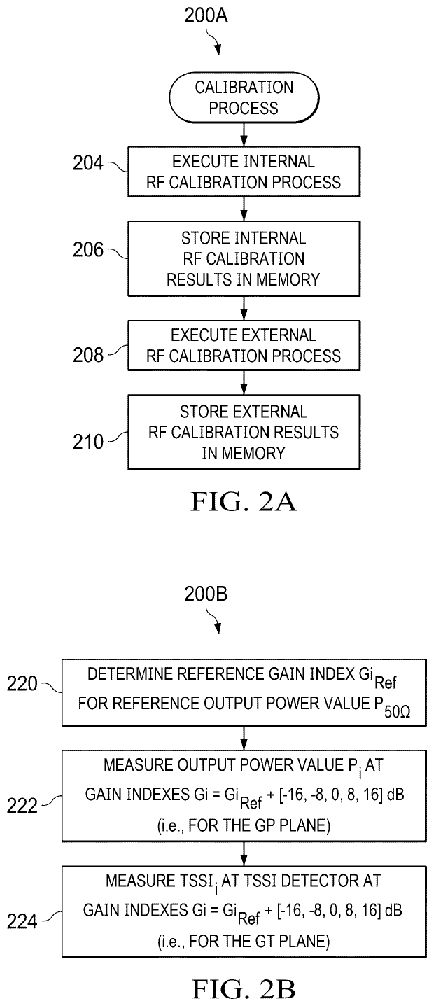

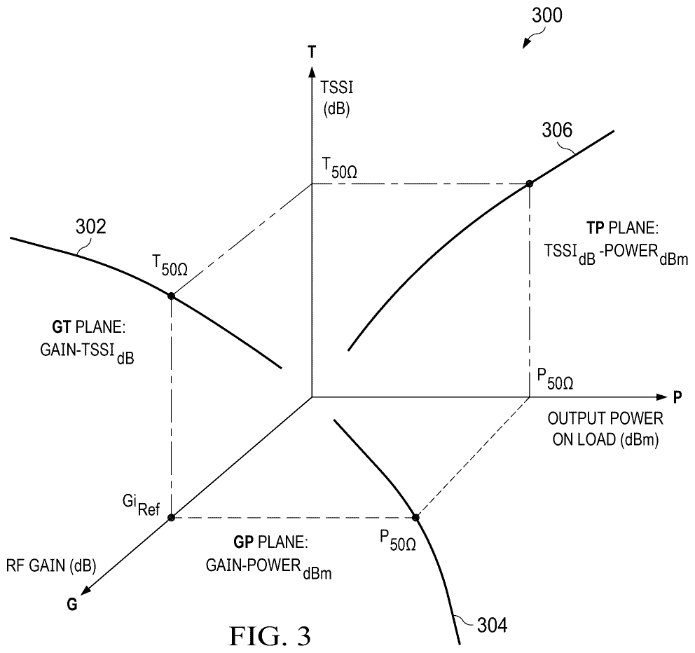

FIG. 2A is a flowchart of a method 200A of one or more calibration processes of the RF signal transmitting apparatus of FIG. 1. The one or more calibration processes are one or more factory calibration processes for the RF signal transmitting apparatus. In one or more examples, the one or more calibration processes are executed with respect to a predetermined impedance (e.g., about 50 ohms), starting at a predetermined temperature (e.g., about 25 degrees Celsius) at a predetermined operating voltage (e.g., about 3.3 volts) of RF signal transmitting apparatus. In one or more examples, external test measurement equipment (e.g., external test measurement equipment 150 of FIG. 1) is used for measurements (e.g., measurements of output power values of RF signal transmitting apparatus 101).

At an act 204, an internal RF calibration process is executed, and at an act 206, at least some of the internal RF calibration results of the internal RF calibration process are stored in memory. In one or more examples, the internal RF calibration results may be associated with bandgap reference, local oscillator (LO) bias, tank (e.g., tank frequency), transmit LO feedthrough (loft), transmit in-phase (I) and quadrature (Q) signals, and DPD values. At an act 208, an external RF calibration process is executed, and at an act 210, at least some of the external RF calibration results of the external RF calibration process are stored in memory. As one or more examples, the external RF calibration results may be associated with temperature/supply voltage (V_{DD})) readings and transmit power control (TPC)/TSSI measurements.

FIG. 2B is a flowchart of a method 200B of one or more calibration processes of the RF signal transmitting apparatus of FIG. 1. The one or more calibration processes of method 200B may be a part of the one or more calibration processes of method 200A of FIG. 2A (e.g., acts 208 and 210 of FIG. 2A). Again, in one or more examples, external test measurement equipment (e.g., external test measurement equipment 150 of FIG. 1) may be used for measurements of output power values. In the one or more calibration processes, a suitable load having the predetermined impedance may be used with the RF signal transmitting apparatus.

The RF transmitter front-end may be designed and developed to transmit at a target output power (e.g., about 17 dBm) with respect to the predetermined impedance (e.g., about 50 ohms). Initially, a reference output power value P_{50Ω} corresponding to the target output power (e.g., about 17 dBm) is identified. At an act 220, a reference gain index G_{iRef} to achieve the reference output power value P_{50Ω} is determined.

At an act 222, an output power value Pᵢ is measured at each respective gain index and stored in memory. In one or more examples, the respective gain indexes are determined relative to the reference gain index G_{iRef}. For example, the respective gain indexes may be expressed as an array of values, such as in the form of Gi=G_{iRef}+[−b, −a, 0, a, b], where “a” and “b” (and so on) are fixed constants (e.g., according to a sequence pattern in the sequence of values). As a specific, non-limiting example, output power values are measured and stored in relation to respective gain indexes Gi=Gi_{Ref}+[−16, −8, 0, +8, +16]. Thus, act 222 provides a mapping of gain index to transmit output power.

At an act 224, a TSSI value TSSI; at the TSSI detector is measured at each respective gain index. Again, for example, the respective gain indexes may be expressed as an array of values, such as in the form of Gi=Gi_{Ref}+[−b, −a, 0, a, b], such as Gi=Gi_{Ref}+[−16, −8, 0, +8, +16]. In the specific, non-limiting example, the TSSI values are measured and stored in relation to respective gain indexes Gi=Gi_{Ref}+[−16, −8, 0, +8, +16]. Thus, act 224 provides a mapping of gain index to TSSI.

In act 224, TSSI values are obtained using measurements at the TSSI detector (e.g., the peak detector) coupled to the output of the RF PA (FIG. 1). The peak detector measures voltage at its terminals, and therefore provides a voltage-based measurement indicative of output power measured at the peak detector. When the load is matched, the output power measured at the peak detector will correspond to the output power observed on the load, but typically not when the load is mismatched.

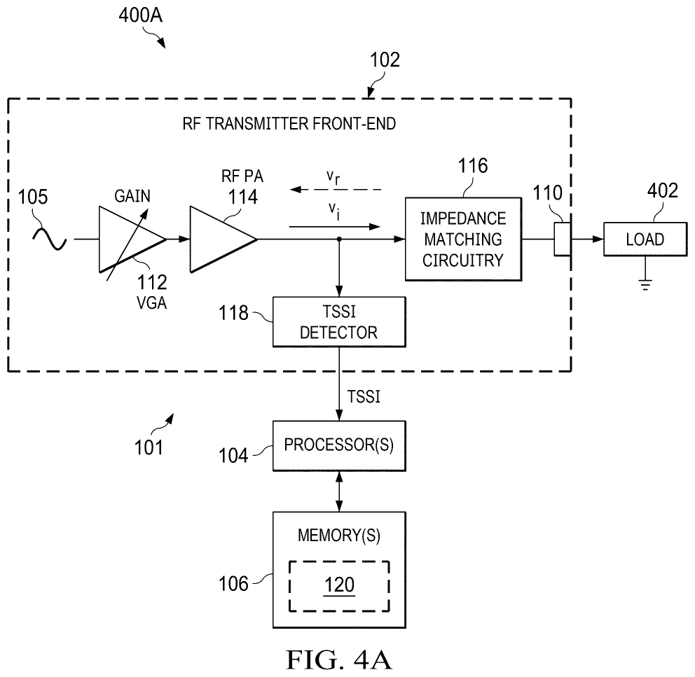

Accordingly, from the one or more calibration processes, one or more stored mappings of calibrated values (e.g., one or more stored mappings 120 in memory 106 of FIG. 1) at least between gain indexes, TSSI values, and output power values are generated and stored in memory. The one or more stored mappings of calibrated values are graphically represented as shown and described below in relation to FIG. 3. The one or more stored mappings may include a reference gain index Gi_{Ref}, a reference TSSI value T_{50Ω} associated with the reference gain index Gi_{Ref}, and a reference output power value P_{50Ω} associated with the reference gain index Gi_{Ref}. The one or more processors of the RF signal transmitting apparatus are adapted to control and monitor transmit output power of the RF signals at least partially based on the one or more stored mappings of calibrated values.

FIG. 3 is a three-dimensional plot 300 of calibrated values for the RF signal transmitting apparatus of FIG. 1. Plot 300 graphically represents at least some of the calibrated values used to control and monitor transmit output power of RF signals transmitted through the RF transmitter front-end (e.g., RF transmitter front-end 102 of FIG. 1).

In one or more examples, plot 300 is based on the one or more stored mappings of calibrated values from the one or more calibration processes of method 200B of FIG. 2B. The calibrated values in plot 300 are based on RF transmission from the RF transmitter front-end with respect to a load having a predetermined impedance (e.g., about 50 ohms). The calibrated values in plot 300 include relationships or associations between gain indexes, TSSI values, and output power values, and also include the reference gain index Gi_{Ref}, the reference TSSI value TSSI_{50Ω} associated with the reference gain index Gi_{Ref}, and the reference output power value P_{50Ω} associated with the reference gain index Gi_{Ref}. As is apparent, the one or more calibration processes provide a one-to-one relation between the TSSI values measured at the TSSI detector and the actual output power on the load.

More specifically, plot 300 indicates output power (P) versus RF gain (G) and TSSI (T), where output power (P) is indicated along the “x” or horizontal axis, TSSI (T) is indicated along the “y” or vertical axis, and RF gain (G) is indicated along the “z” or diagonal axis. Plot 300 includes a Gain-TSSI (GT) curve 302 associated with a Gain-to-TSSI relationship in a “GT plane,” a Gain-Power (GP) curve 304 associated with a Gain-to-Power relationship in a “GP plane,” and a TSSI-Power (TP) curve 306 associated with a TSSI-to-Power relationship in a “TP plane.” Notably, the RF gain relates the GT and GP planes to provide the TP plane. Every measured point on the GT plane can be easily mapped to the GP plane using the 50 ohm calibrated values, as depicted in FIG. 3.

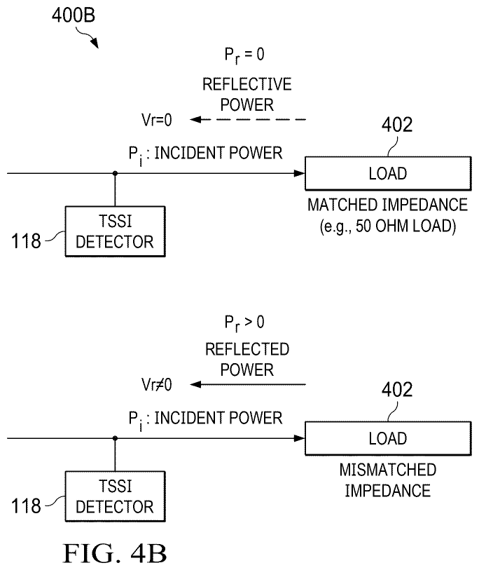

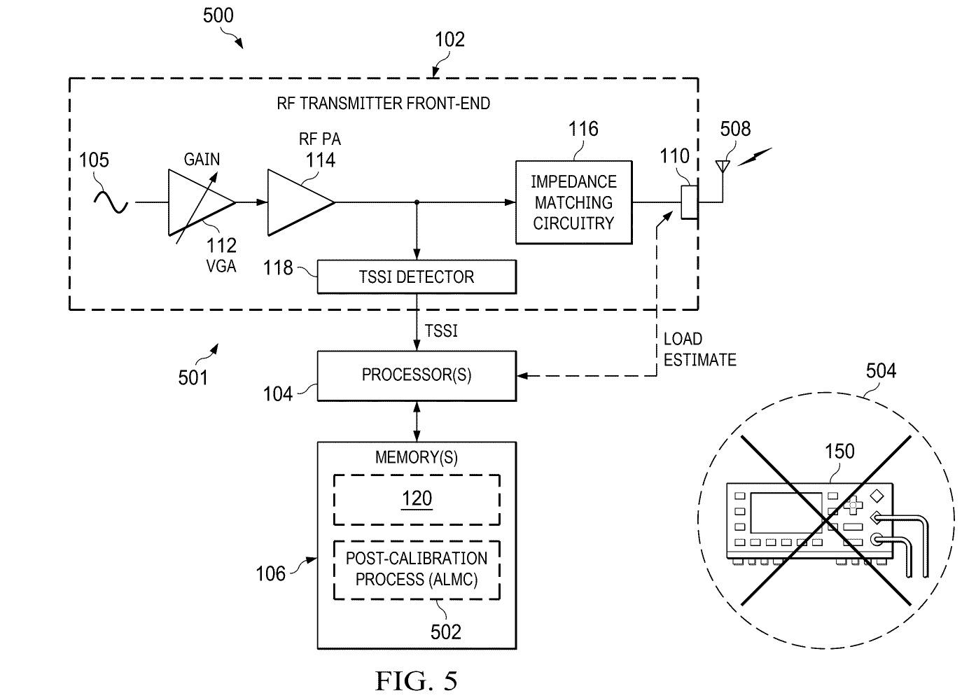

FIG. 4A is a schematic block diagram of an apparatus 400A comprising the RF signal transmitting apparatus 101 of FIG. 1 for observation of load conditions. FIG. 4B is a schematic diagram portion 400B of the RF signal transmitting apparatus of FIG. 4A, with a top portion representing a matched load condition and a bottom portion representing a mismatched load condition.

As discussed earlier, the values of the components of impedance matching circuitry 116 are selected in advance to match an expected, suggested, or predetermined impedance of a load 402 (e.g., about 50 ohms). Impedance matching optimizes the transfer of output power and prevents power reflections that reduce RF transmission efficiency. A Voltage Standing Wave Ratio (VSWR) is a primary metric that may be used to describe how well an antenna is matched to the 50 ohm load. In general, the closer the VSWR of the antenna is to one (1), the better the antenna will match the 50 ohm load.

As the RF signal passes through the RF PA, the voltage induced over TSSI detector 118 measures the TSSI. The voltage observed at TSSI detector 118 (e.g., the peak detector) may be represented as v_{TD}=vᵢ+vᵣ, where vᵢ is the intrinsic voltage and vᵣ is the reflective voltage. Also, Pᵢ is incident power and Pᵣ is reflective power. When load 402 is at VSWR=1, then vᵣ=0, and therefore the voltage at TSSI detector is v_{TD}=vᵢ which is proportional to the output power passing through RF PA 114 (see, e.g., the top portion of FIG. 4B). As long as there is no reflected wave from load 402 (i.e., there is a perfect impedance match), the voltage across TSSI detector 118 is only related to the intrinsic voltage passing toward load 402, as the load would not reflect anything back.

However, when load 402 suffers from a mismatch (e.g., load≠50 ohms and VSWR>1), the measured TSSI values at TSSI detector 118 do not resemble the TSSI values stored from the factory calibration (see, e.g., the bottom portion of FIG. 4B). The reason is that the voltages observed at the terminals of TSSI detector 118 are now affected by the induced reflective wave, and the superposition of the intrinsic and reflective voltages is now different from that of the factory calibrated values.

Accordingly, the antenna to be selected for use with RF signal transmitting apparatus 101 is generally recommended to be as close as possible to 50 ohms. Nevertheless, it would be advantageous to allow a wider selection of antennas with different impedances for RF signal transmitting apparatus 101. The ability of RF signal transmitting apparatus 101 to operate effectively with other antenna impedances would allow users to choose from any number of different antennas, such as an antenna that is widely available, more economical, or better suited for a particular application. For example, most commercial dipole antennas have a VSWR of close to 2 or greater. Although the impact of VSWR on the system is significant, such a restricted VSWR selection (e.g., 50 ohms, where VSWR=1) limits the antennas the users can choose. Antenna impedance flexibility would provide RF signal transmitting apparatus 101 with a key marketing advantage.

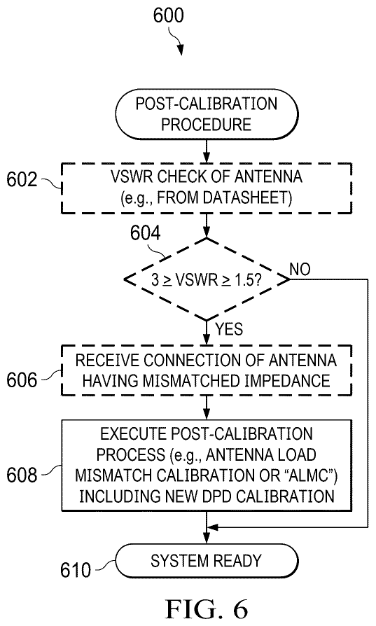

FIG. 5 is a schematic block diagram of an apparatus 500 comprising RF signal transmitting apparatus 501 of an RF transmitter, according to one or more examples of the disclosure. In FIG. 5, RF signal transmitting apparatus 501 may be the same or similar to RF signal transmitting apparatus 101 of FIG. 1, except that RF signal transmitting apparatus 501 of FIG. 5 includes a post-calibration process 502 for an antenna 508 that is a mismatched antenna.

In one or more examples, post-calibration process 502 of FIG. 5 may be or be referred to as an antenna load mismatch calibration (ALMC) process. Post-calibration process 502 (e.g., the ALMC) may be implemented as processor-executable instructions stored in a non-transitory storage medium (e.g., memory 106), where the processor-executable instructions are executable by one or more processors 104 (e.g., software executed by an MCU). In one or more examples, post-calibration process 502 is a simple, user-friendly, and fast post-calibration process (e.g., a recalibration process) that provides, without the need for external equipment 150 (as indicated in a view window 504), stable transmit output power and an acceptable EVM even using antenna 508 that is not properly matched (e.g., not matched to 50 ohms), thereby providing adequate or even mostly perfect (at least in many instances) RF signal transmission despite the mismatched antenna. For example, the recalibrated values may provide increased transmission efficiency and/or reduce distortion with respect to the RF signals transmitted from RF transmitter front-end 102 via antenna 508 having the mismatched impedance.

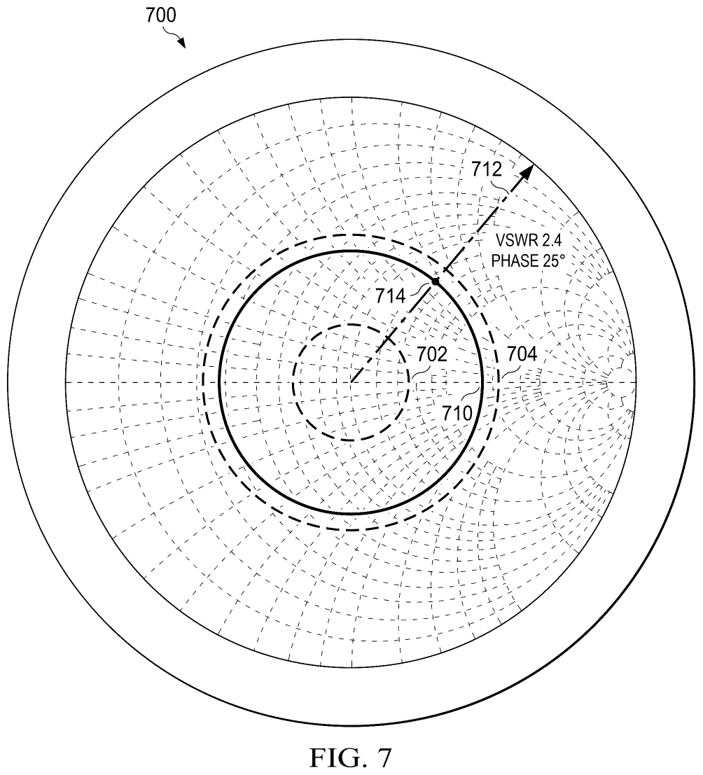

FIG. 6 is a flowchart of a method 600 of a post-calibration procedure for RF signal transmitting apparatus 501 of FIG. 5, according to one or more examples. When the finished good or product (e.g., an IC product including the RF signal transmitting apparatus) is available on the market, a user (e.g., designer, engineer, or technician) selects an antenna for use with the RF signal transmitting apparatus. The selected antenna may have an impedance that is mismatched with respect to the expected, suggested, or predetermined impedance (e.g., about 50 ohms).

At an act 602, a check of the VSWR of the antenna having the mismatched impedance is made. In one or more examples, the check of the VSWR of the antenna is made based on information in a datasheet. At an act 604, if the VSWR is determined to be greater than or equal to about 1.5 (e.g., and less than or equal to about 3), then, at an act 606, the RF signal transmitting apparatus receives connection of the antenna and, at an act 608, a post-calibration process is executed with the antenna. In one or more examples, the post-calibration process of act 608 may be a user calibration process, for example, initiated or invoked at least in part by the user (e.g., designer, engineer, or technician). In one or more examples, the user may input the determined VSWR for processing in the post-calibration process. After the post-calibration process of act 608, at an act 610 (“System Ready”), the antenna may be used with the RF signal transmitting apparatus. Otherwise, at act 604, if the VSWR is determined to be less than about 1.5 (e.g., or greater than about 3), then the post-calibration process may be bypassed (not executed), and at act 610 (“System Ready”), the antenna may be used with the RF signal transmitting apparatus without the post-calibration process (e.g., as long as the VSWR is not greater than about 3). Accordingly, the post-calibration process of act 608 is executed with respect to an antenna having a VSWR that is determined, at act 604, to be between about 1.5 and 3 (or between another suitable predetermined range of values in one or more other examples).

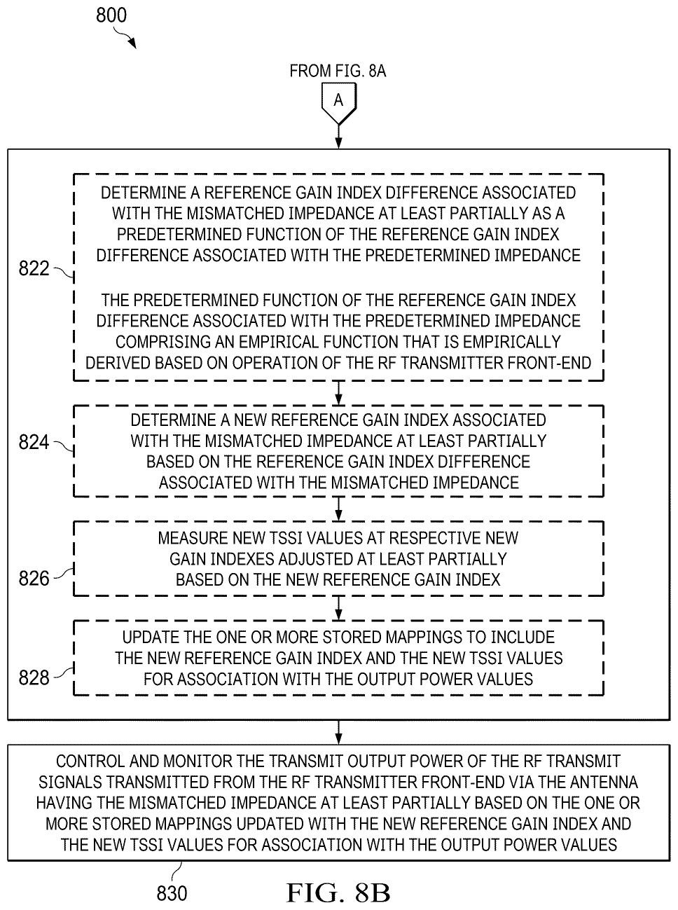

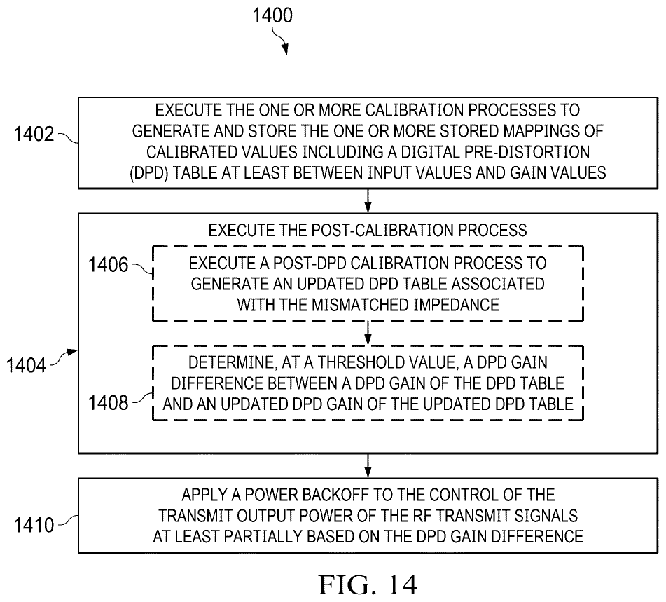

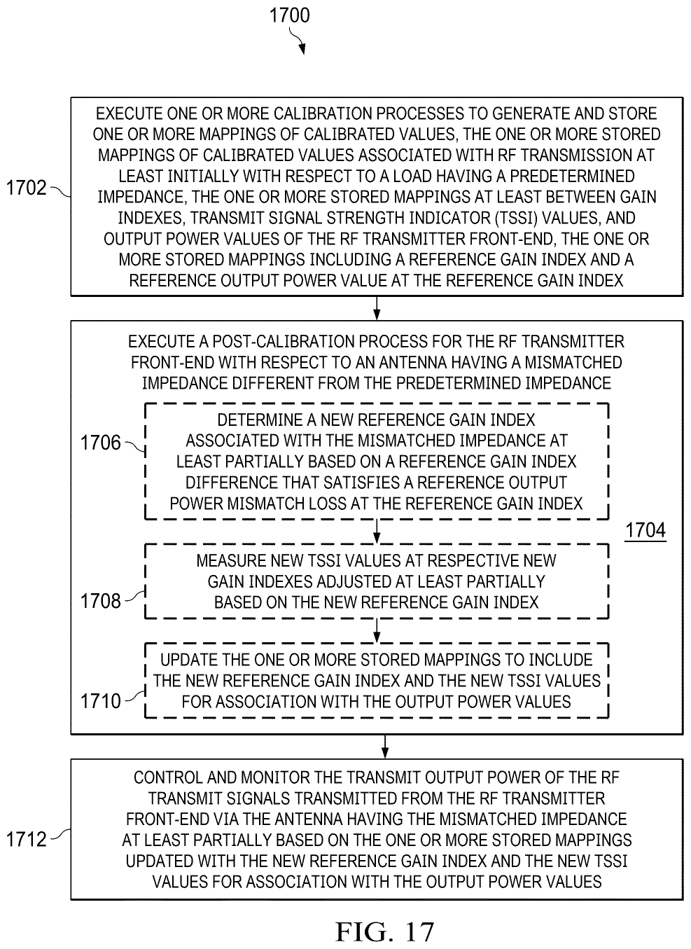

In FIG. 6, the post-calibration process of act 608 may be post-calibration process 502 in RF signal transmitting apparatus 501 of FIG. 5. In one or more examples, the post-calibration process of act 608 is the post-calibration process described later in relation to method 800 of FIGS. 8A and 8B and/or method 1700 of FIG. 17. In one or more examples, the post-calibration process of act 608 includes a post-DPD calibration process, for example, as described later in method 1400 of FIG. 14.

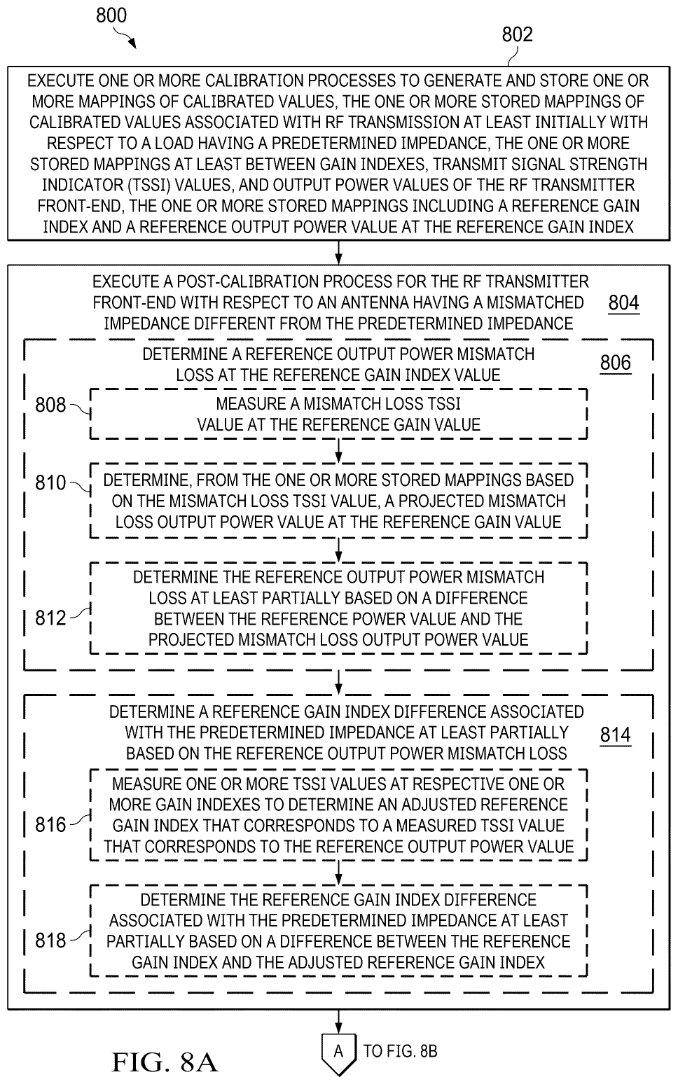

FIG. 7 is a Smith chart 700 used to characterize an antenna for an RF signal transmitting apparatus 501 of FIG. 5, according to one or more examples. The innermost circle of Smith chart 700 represents a perfectly matched impedance for an antenna's RF transmitter front-end. As discussed previously, the post-calibration process of the RF transmitter front-end (e.g., act 608 of FIG. 6) is adapted for use in relation with an antenna having a mismatched impedance. Note that the inability to adjust to match for each antenna due to the PCB layout poses a challenge, and the above may even be true for a system that has already passed certifications. In one or more examples, the post-calibration process is adapted for an antenna having a mismatched impedance associated with a VSWR of between about 1.5 and 3 (e.g., act 604 of FIG. 6). In Smith chart 700, a VSWR of 1.5 is indicated by a constant VSWR circle 702 and a VSWR of 3 is indicated by a constant VSWR circle 704.

In a specific, non-limiting example, an antenna having a mismatched impedance for use with the RF transmitter front-end is represented by a constant VSWR circle 710 indicating a VSWR of 2.4. Depending on the projection of the antenna load and the matching circuit, the load may be indicated at any point on this circle. When designing for a specific VSWR, all of the angles that apply to the load can be examined; the angles will change between −180 degrees to 180 degrees. In the specific example of FIG. 7, a line 712 indicates a phase angle of the reflection coefficient to be 25 degrees; a point 714 on constant VSWR circle 710 that intersects with line 712 indicates an impedance having a VSWR of 2.4 and a phase angle of the reflection coefficient to be 25 degrees.

In general, the VSWR of an antenna may be determined based on the following expression(s)

$$VSWR = \frac{1 + \vert Γ \vert}{1 - \vert Γ \vert} \\ or \\ VSWR = \frac{1 + \vert \frac{{Z}_{L} - {Z}_{c}}{{Z}_{L} + {Z}_{c}} \vert}{1 - \vert \frac{{Z}_{L} - {Z}_{c}}{{Z}_{L} + {Z}_{c}} \vert}$$

where Γ=abs((Z_{L}−Z_{C})/(Z_{L}+Z_{C})), Z_{c} is the characteristic impedance, and Z_{L} is the load impedance.

In general, where 3≥VSWR≥1.5 is a condition to invoke the post-calibration process (e.g., where 0.2≤|Γ|<0.5), then 16.7Ω<Z_{L}≤33.3Ω or 75Ω≤Z_{L}<150Ω.

In a specific, non-limiting example, if an antenna has a mismatched impedance of 45Ω, that is, Z_{C}=50Ω and Z_{L}=45Ω, then Γ=abs ((50−45)/(50+45))=0.0526, and VSWR=(1+abs(0.0526))/(1−abs(0.0526))=1.11, and 1.11≤1.5. Thus, this mismatched antenna, the post-calibration process does not need to be executed.

In another specific, non-limiting example, if an antenna has a mismatched impedance of 33Ω, that is, Z_{C}=50 Ω and Z_{L}=33Ω, then Γ=abs((50−33)/(50+33))≈0.20482, and VSWR=(1−abs(0.20482))/(1+abs(0.20482))≈1.5152, and 1.5152≥1.5. Thus, for this mismatched antenna, the post-calibration process should be executed to improve RF transmission performance.

FIGS. 8A and 8B form a flowchart of a method 800 of processing to operate an RF signal transmitting apparatus that includes a post-calibration process, according to one or more examples of the disclosure. In one or more examples, method 800 is executed by apparatus 500 including RF signal transmitting apparatus 501 of FIG. 5 (e.g., post-calibration process 502). In one or more examples, method 800 is executed at one or more processors adapted to control and monitor transmit output power of RF signals transmitted through the RF transmitter front-end. In one or more examples, method 800 is implemented as processor-executable instructions stored in a non-transitory storage medium, where the processor-executable instructions are executable by the one or more processors to execute method 800 of FIGS. 8A and 8B.

More particularly, in one or more examples, method 800 is implemented as software in an MCU, where the RF transmitter front-end is provided in an ASIC, which shares memory registers of memory with the MCU. In one or more examples, the ASIC executes TSSI measurements that are provided to higher layers controlled by the MCU (for application and MAC layer processes). For example, the output of the TSSI detector may lead to an ADC of the MCU where digital values are stored in the memory registers. The MCU may be utilized to initiate method 800, where hardware routines in the RF and PHY layers are invoked and outputs conveyed to the MCU through memory registers.

At an act 802 of FIG. 8A, one or more calibration processes are executed to generate and store one or more mappings of calibrated values associated with RF transmission from the RF transmitter front-end at least initially with respect to a load having a predetermined impedance (e.g., about 50 ohms). The one or more stored mappings are at least between gain indexes, TSSI values, and output power values of the RF transmitter front-end. The one or more stored mappings include a reference gain index and a reference output power value associated with the reference gain index. In one or more examples, the one or more calibration processes may be one or more factory calibration processes. In one or more examples, the one or more calibration processes at act 802 include connection of the RF transmitter front-end to external test measurement equipment adapted to measure the output power values of the RF signal transmission at the load.

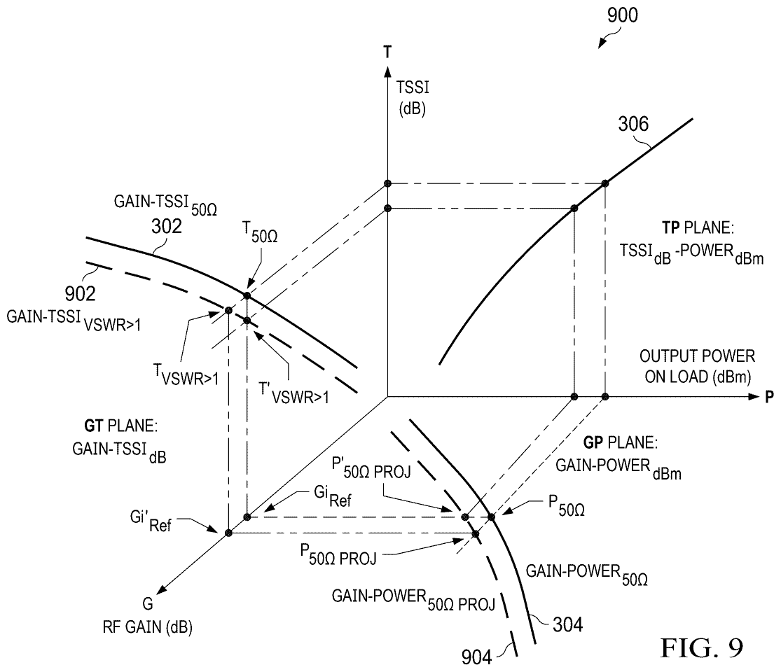

With respect to act 802 of FIG. 8A, FIG. 9 is a three-dimensional plot 900 of calibrated values for the RF signal transmitting apparatus, according to one or more examples. Plot 900 indicates the calibrated values of the one or more stored mappings of calibrated values described previously in relation to FIG. 3. For example, plot 900 depicts GT curve 302 associated with the Gain-to-TSSI relationship in the GT plane, GP curve 304 associated with the Gain-to-Power relationship in the GP plane, and TP curve 306 associated with the TSSI-to-Power relationship in the TP plane. Also in plot 900, the reference gain index Gi_{Ref} is associated with the reference TSSI value T_{50Ω}, which is associated with the reference output power value P_{50Ω}.

After factory calibration, when the finished good or product (e.g., an IC product including the RF signal transmitting apparatus) is available on the market, a user (e.g., designer, engineer, or technician) selects an antenna for use with the RF signal transmitting apparatus. The selected antenna has an impedance that is mismatched with respect to the predetermined impedance used for calibration.

Referring back to FIG. 8A, at an act 804, a post-calibration process for the RF transmitter front-end is executed with respect to the antenna having the mismatched impedance different from the predetermined impedance. In one or more examples, the post-calibration process of act 804 may be a user calibration process, for example, initiated or invoked at least in part by the user (e.g., designer, engineer, or technician). In one or more examples, the post-calibration process of act 804 is executed with respect to an antenna having a mismatched impedance associated with a VSWR of between about 1.5 and 3. In one or more examples, a determination regarding whether to initiate or invoke the post-calibration process based on the VSWR of the antenna in act 804 is made at least in part by the user of the RF transmitter including the RF transmitter front-end (e.g., acts 604 and 606 of method 600 of FIG. 6).

Regarding the antenna having the mismatched impedance, what is further depicted in FIG. 9 is a mismatched impedance GT curve 902 (i.e., a “Gain-TSSI_{VSWR>1}” curve) associated with a mismatched impedance Gain-to-TSSI relationship in the GT plane. In addition, what is further depicted in FIG. 9 is a projected mismatched impedance GP curve 904 (i.e., a “Gain-Power_{50Ω Proj}” curve) associated with a projected mismatched impedance Gain-to-Power relationship in the GP plane. A mismatch loss TSSI value T′_{VSWR>1} is indicated on mismatched impedance GT curve 902, and a projected mismatch loss output power value P′_{50Ω Proj} is indicated on projected mismatched impedance GP curve 904.

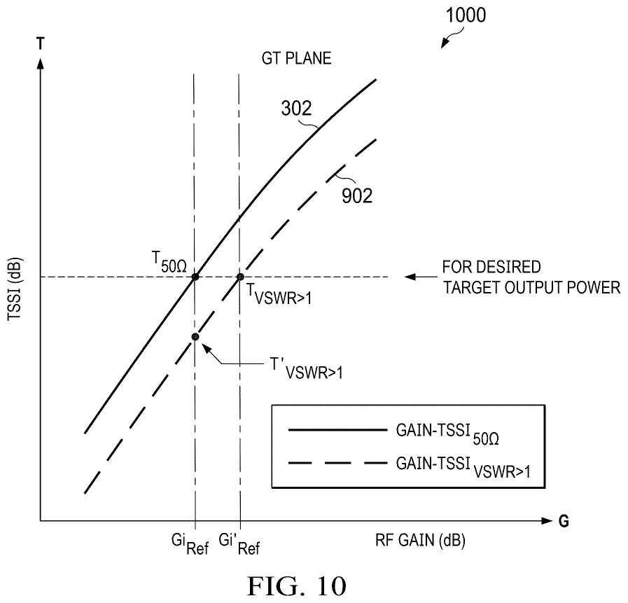

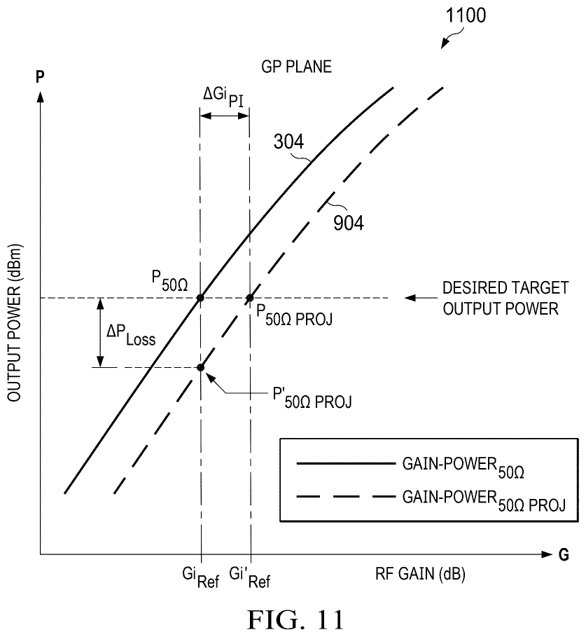

Based on the GT plane of plot 900 of FIG. 9, FIG. 10 is a two-dimensional plot 1000 of TSSI versus RF gain of the GT plane, according to one or more examples. Plot 1000 includes GT curve 302 associated with the Gain-to-TSSI relationship in the GT plane and also mismatched impedance GT curve 902 (i.e., the Gain-TSSI_{VSWR>1} curve) associated with the mismatched impedance Gain-to-TSSI relationship in the GT plane. Based on the GP plane of plot 900 of FIG. 9, FIG. 11 is a two-dimensional plot 1100 of output power versus RF gain of the GP plane, according to one or more examples. Plot 1100 includes GP curve 304 associated with the Gain-to-Power relationship in the GP plane and also projected mismatched impedance GP curve 904 (i.e., the Gain-Power_{50Ω Proj} curve) associated with the projected mismatched impedance Gain-to-Power relationship in the GP plane.

In general, the visual representations in FIGS. 10 and 11 depict how the load mismatch (e.g., VSWR>1) can alter the measured TSSI and output power at the load in the GT and GP planes, respectively. In the mismatched load system, what is measured is T′_{VSWR>1} on the GT_{VSWR>1} curve (FIG. 10) instead of the expected T_{50Ω}. Curve shifts in the same direction are evident, with T′ and P′ points (FIGS. 10 and 11) consistently decreasing or increasing due to the load mismatch. For example, in FIG. 10, the TSSI measured value (e.g., T′_{VSWR>1}) is lower than expected at the reference gain index Gi_{Ref}. Hence, the TSSI measurements at the factory may correspond to the target output power observed at the load in a matched 50 ohm system, but any mismatched load would tend to disrupt the targeted power. Here, the delivered output power to the load could be higher or lower as compared to the 50 ohm load, and should be corrected.

At an act 806 of FIG. 8A, a reference output power mismatch loss (e.g., ΔP_{Loss}) at the reference gain index Gi_{Ref} is determined. See, e.g., FIG. 11 indicating ΔP_{Loss} at the reference gain index Gi_{Ref}. In one or more examples, act 806 may be achieved using an act 808, an act 810, and an act 812. At act 808, a mismatch loss TSSI value (e.g., T′_{VSWR>1}) at the reference gain index Gi_{Ref} is measured (e.g., using TSSI detector 118 of FIG. 5). See, e.g., FIGS. 9 and 10 indicating T′_{VSWR>1} measured at Gi_{Ref}. At act 810, a projected mismatch loss output power value P′_{50Ω Proj} at the reference gain index Gi_{Ref} is determined from the one or stored mappings based on the mismatch loss TSSI value T′_{VSWR>1}. See, e.g., FIGS. 9 and 11 indicating P′_{50Ω Proj} at the reference gain index Gi_{Ref}. At act 812, the reference output power mismatch loss ΔP_{Loss} is determined at least partially based on a difference between the reference power value P_{50Ω} and the projected mismatch loss output power value P′_{50Ω Proj}. See, e.g., FIG. 11 indicating ΔP_{Loss} as the difference between P_{50Ω} and P′_{50Ω Proj}.

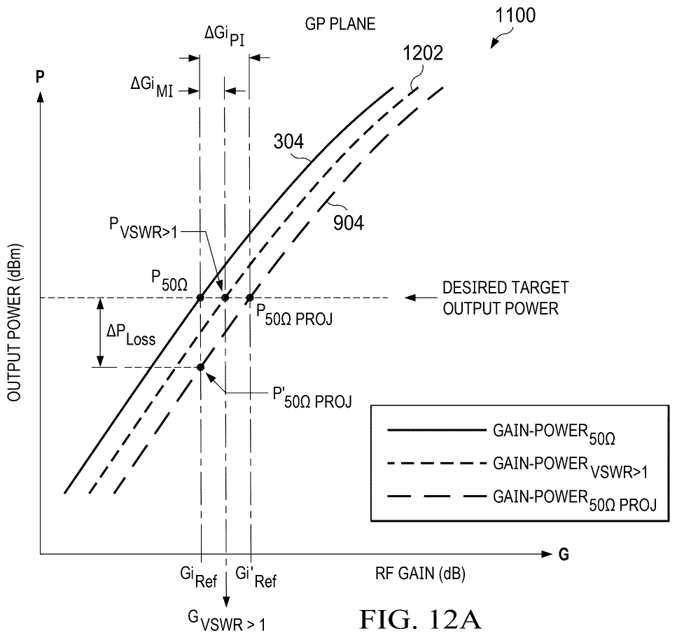

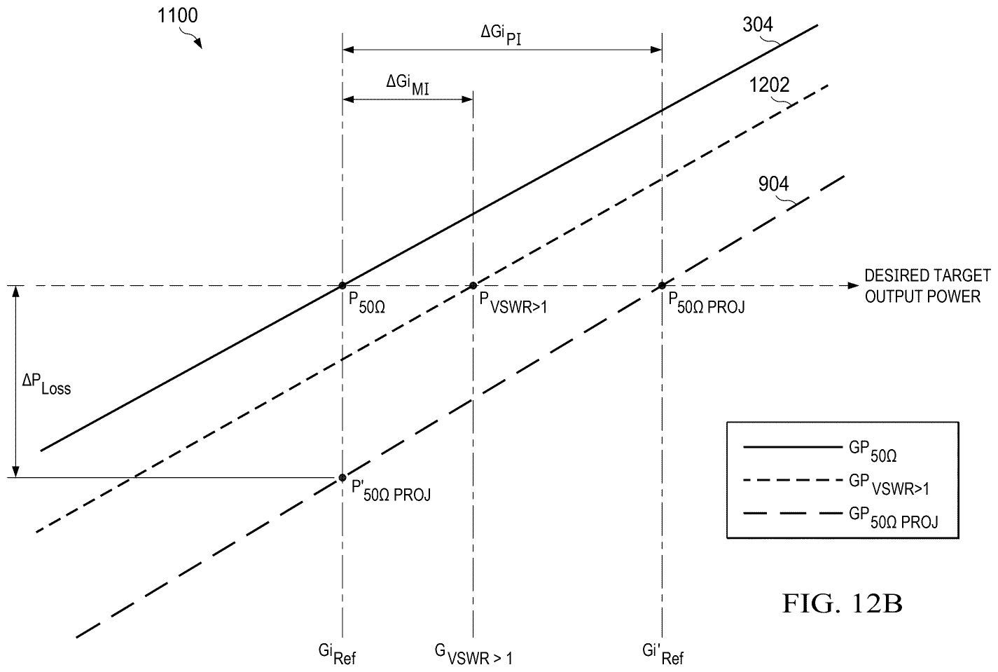

At an act 814 of FIG. 8A, a reference gain index difference associated with the predetermined impedance (e.g., ΔGi_{PI}, where “PI” is predetermined impedance) is determined at least partially based on the reference output power mismatch loss (e.g., ΔP_{Loss}). See, e.g., FIG. 11 indicating ΔGi_{PI} as the difference between Gi_{Ref} and Gi′_{Ref} corresponding to ΔP_{Loss} from P′_{50Ω Proj} to P_{50Ω Proj}. In one or more examples, act 814 may be achieved using an act 816 and an act 818. At act 816, one or more TSSI values are measured at respective one or more gain indexes to determine an adjusted reference gain index (e.g., Gi′_{Ref}) that corresponds to a measured TSSI value (e.g., T_{VSWR>1}) that corresponds to the reference power value (e.g., P_{50Ω Proj}). See, e.g., FIGS. 11 and 12A-12B indicating Gi′_{Ref} corresponding to the desired target output power at P_{50Ω Proj}. At act 818, the reference gain index difference associated with the predetermined impedance (e.g., ΔGi_{PI}) is determined at least partially based on a difference between the reference gain index (e.g., Gi_{Ref}) and the adjusted reference gain index (e.g., Gi′_{Ref}). See, e.g., FIG. 12B indicating ΔGi_{PI} as the difference between Gi_{Ref} and Gi′_{Ref}.

In one or more examples of act 814 (e.g., including acts 816 and 818), the calculation of ΔGi_{PI} involves actual TSSI measurements at the TSSI detector for new TSSIs associated with different gain indexes. For example, the gain index Gi′_{Ref} may be obtained by adjusting (e.g., increasing, as in this example) the gain index until T_{VSWR>1} is measured as indicated on the GT_{VSWR>1} curve (FIG. 10), where each new measured TSSI point has a projection on the GP plane (FIG. 11) based on the TP_{50Ω} curve (FIG. 9). Note that ΔP_{Loss} corresponds to a particular gain change that is not immediately ascertainable as the relationship is non-linear. In one or more examples, an iterative process is used to obtain the gain index difference. As TSSI is mapped to output power and vice versa, the gain index is adjusted (e.g., involving a new TSSI measurement corresponding to a new projected power) in the direction of change to make up for the remaining gap in output power.

In one or more examples, an iterative process that is equivalent to a Newton-Raphson method is used to solve for Gi′_{Ref}. The number of iterations needed to obtain Gi′_{Ref} may depend on how linear the region of the curve is being traversed. In one example, ΔP_{Loss} can be used as an initial value in the Newton-Raphson method, and the iterations may continue until the power difference is zero. As the tested value is not always linear, it may take up to three (3) iterations (e.g., from one (1) to up to three (3) iterations) to identify the adjusted gain index Gi′_{Ref}, and therefore to identify ΔGi_{PI}=Gi_{Ref}−Gi′_{Ref}.

In FIG. 11, projected mismatched impedance GP curve 904 (i.e., the Gain-Power_{50Ω Proj} curve) is characterized as “projected” as the mapping on the GP plane does not reflect the actual power on the load when the load is mismatched. Due to the load mismatch, the projection is either an overestimation or an underestimation of the actual power on the load. Relying on this projection mapping only would result in power fluctuation. What is therefore further sought after is a reference gain index difference associated with the mismatched impedance (e.g., ΔGi_{MI}, where “MI” is mismatched impedance), which may be determined as a predetermined function of ΔGi_{PI} (i.e., ΔGi_{MI}=f(ΔGi_{PI})), as will be discussed below in relation to FIGS. 12A and 12B.

FIG. 12A is plot 1100 of the output power versus RF gain from the GP plane of FIG. 11, further indicating a target mismatched impedance GP curve 1202 (i.e., a “Gain-Power VSWR 1” curve) associated with a target mismatched impedance Gain-to-Power relationship in the GP plane, according to one or more examples. Target mismatched impedance GP curve 1202 falls in between GP curve 304 (i.e., the Gain-Power 500 curve) and projected mismatched impedance GP curve 904 (i.e., the Gain-Power_{50Ω Proj} curve). FIG. 12B is a close-up view of plot 1100 of FIG. 12A, further indicating the reference gain index difference associated with the predetermined impedance (e.g., ΔGi_{PI}=Gi_{Ref}−Gi′_{Ref}) and a reference gain index difference associated with the mismatched impedance (e.g., ΔGi_{MI}=Gi_{Ref}−G_{VSWR>1}), which can be used to determine a new reference gain index G_{VSWR>1}.

Target mismatched impedance GP curve 1202 is a desired goal of the estimation and indicates the power estimation delivered to the mismatched load. Continuation of method 800 will estimate target mismatched impedance GP curve 1202 (Gain-Power_{VSWR>1}) from projected mismatched impedance GP curve 904 (Gain-Power_{50Ω Proj}). The remaining part of the projection analysis relates to how P_{VSWR>1} is obtained on target mismatched impedance GP curve 1202 (Gain-Power_{VSWR>1}).

Continuing the acts of method 800 in FIG. 8B through a connector A, at an act 822, a reference gain index difference associated with the mismatched impedance (e.g., ΔGi_{MI}, where “MI” is mismatched impedance) is determined as a predetermined function of the reference gain index difference associated with the mismatched impedance (i.e., ΔGi_{MI}=f(ΔGi_{PI})). See, e.g., FIG. 12B indicating ΔGi_{MI}, which is a function of ΔGi_{PI}. ΔGi_{MI} is the gain index change used to get the desired target output power on the mismatched load at P_{VSWR>1} at the gain index of G_{VSWR>1}. One can calculate ΔGi_{PI} to input into the predetermined function to obtain the gain index shift used to calculate the actual position of P_{VSWR>1} corresponding to G_{VSWR>1}.

In one or more examples, the predetermined function comprises a non-linear function of the reference gain index difference associated with the predetermined impedance. In one or more examples, the predetermined function ΔGi_{MI}=f(ΔGi_{PI}) is a non-linear polynomial in the form of ΔGi_{MI}=A*(ΔGi_{PI})²+B*(ΔGi_{PI})+C, where A, B, and C are coefficients that are constants (e.g., fixed numerical values). In one or more examples, the non-linear polynomial may be stored efficiently in memory by storing (e.g., only or primarily) the coefficients of the non-linear polynomial.

In one or more examples, the predetermined function comprises an empirical function of the reference gain index difference associated with the predetermined impedance. The empirical function may be empirically derived at least partially based on operation of the RF transmitter front-end. In one or more examples, the empirical function is used across all RF transmitter front-ends of the same or similar design type (e.g., stored in memory in the form of stored coefficients).

In one or more specific examples, the empirical function is a non-linear polynomial that has been determined empirically based on operation of the RF transmitter front-end (RF transmitter front-end 502 of FIG. 5) as ΔGi_{MI}=round(−0.0108*(ΔGi_{PI})²−0.6300*(ΔGi_{PI})+3.1203).

At an act 824 of FIG. 8B, a new reference gain index associated with the mismatched impedance (e.g., G_{VSWR>1}) is determined at least partially based on the reference gain index difference associated with the mismatched impedance (e.g., ΔGi_{MI}). See, e.g., FIG. 12B indicating the new reference gain index G_{VSWR>1} which may be determined from ΔGi_{MI}.

At an act 826, new TSSI values are measured at respective new gain indexes adjusted at least partially based on the new reference gain index (e.g., G_{VSWR>1}). For example, new TSSI values may be measured at respective new gain indexes Gi_{New}=G_{VSWR>1}+[−b, −a, 0, a, b], instead of respective gain indexes Gi=Gi_{Ref}+[−b, −a, 0, a, b]. At an act 828, the one or more stored mappings are updated to include the new reference gain index (e.g., G_{VSWR>1}) and the new TSSI values for association with the output power values.

In one or more specific examples, determining the new reference gain index comprises applying a gain index shift whose magnitude is given by the predetermined function and whose direction is determined by whether the reference output power mismatch loss indicates an increase or decrease in delivered power.

In one or more examples, the new TSSI values may replace the previous (factory-calibrated) TSSI values. In one or more examples, the one or more stored mappings updated with the new reference gain index and the new TSSI values from the post-calibration process retain the output power values of the one or more stored mappings (i.e., the same previously-stored output power values are still used). Accordingly, in one or more examples, the reference output power value P_{50Ω} is not changed, but the reference gain index and the TSSI values are changed, so that the same output power corresponding to the reference output power value P_{50Ω} is provided under the mismatched load.

At an act 830 of FIG. 8B, the transmit output power of the RF signals transmitted from the RF transmitter front-end via the antenna having the mismatched impedance is controlled and monitored at least partially based on the one or more stored mappings updated with the new reference gain index and the new TSSI values for association with the output power values. In one or more examples, the one or more stored mappings updated with the new reference gain index and the new TSSI values increase transmission efficiency and/or reduce distortion (e.g., in conjunction with DPD recalibration and/or power backoff where applicable, as described in relation to FIG. 14) with respect to the RF signals transmitted from the RF transmitter front-end via the antenna having the mismatched impedance.

In one or more examples, the post-calibration process at act 804 excludes connection of the RF transmitter front-end to external test measurement equipment adapted to measure the transmit output power of the RF signal transmission. Advantageously, no external calibration instrument is required in the post-calibration process. In one or more examples, one advantage of the post-calibration process is to avoid any external calibration instrument and provide all the means to correct with use of internal instruments and data (e.g., the TSSI detector and the factory-calibrated values).

According to one or more examples, the post-calibration process may include correction to digital pre-distortion (DPD) profiles for DPD profile correction. DPD is a linearization technique that uses processing to correct for nonlinear distortions introduced by an RF PA, which causes signal distortion that degrades signal quality, increases spectral emissions, and reduces overall efficiency, especially when operating near its saturation point. DPD compensates for nonlinearities by pre-distorting the signal in the digital domain (e.g., baseband processing prior to the DAC/RF PA), while power backoff (implemented, for example, by lowering the RF VGA gain) is applied based on the DPD gain difference when the updated DPD profile indicates compression. Both methods help in creating a substantially linear system to enable the RF PA to operate at higher power levels while maintaining signal integrity and efficiency.

DPD profiles may include specific parameters and models (e.g., for a pre-distorter) to accurately linearize the RF PA. A DPD system analyzes the non-linear behavior of the RF PA to create a pre-distortion signal that counteracts the behavior based on the DPD profiles, ensuring it remains more nearly linear within the specification. In general, the DPD profiles may include one or more DPD tables including stored mappings of calibrated values associated with the predetermined impedance (e.g., about 50 ohms). More particularly, the DPD profiles may include amplitude modulation to amplitude modulation (AM-AM) and amplitude modulation to phase modulation (AM-PM) profiles of the RF PA, which are calibrated at the predetermined impedance (e.g., about 50 ohms). Due to load mismatch, the AM-AM and AM-PM profiles will differ, and therefore adjustment may be needed.

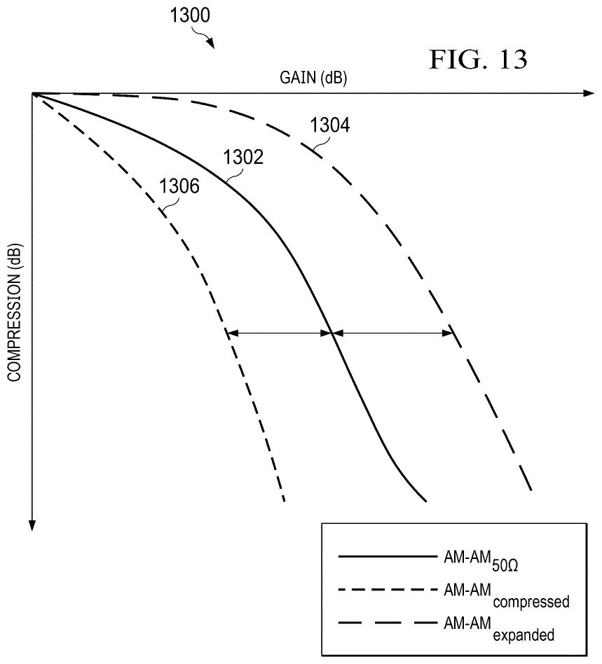

FIG. 13 is a plot 1300 of an AM-AM curve 1302 for an RF PA that includes two mismatched load profiles, according to one or more examples. AM-AM curve 1302 characterizes the RF PA before DPD is applied, revealing a non-linear decrease in the output power at higher input power levels. With an ideal, perfectly linear RF PA, curve 1302 would be a straight diagonal line. With a real-world RF PA, however, curve 1302 bends and tends to flatten out as the input power increases. This downward curvature is the effect of gain compression. With respect to the mismatched load profiles, an AM-AM compressed scenario (e.g., a curve 1306) occurs when an increase in power amplifier gains, and hence an increase in input, the output grows less than at 50 ohms, which leads to more significant compression. Conversely, an AM-AM expanded scenario (e.g., a curve 1304) occurs when a more substantial gain, and hence a resulting increased input, results in an output growth of more than at 50 ohms, which results in less compression than its 50 ohm counterpart.

FIG. 14 is a flowchart of a method 1400 of processing to operate an RF signal transmitting apparatus that includes a post-calibration process for DPD profile correction, according to one or more examples of the disclosure. In one or more examples, the post-calibration process of act 1406 below is invoked before or alongside method 800 (act 804 thereof) of FIGS. 8A-8B to refresh DPD for the mismatched load. In some examples, act 1406 below (post-DPD calibration) runs at the outset, and the results thereof are used in method 800.

At an act 1402, the one or more calibration processes are performed to generate and store one or more mappings of calibrated values associated with RF transmission from the RF transmitter front-end at least initially with respect to a load having a predetermined impedance (e.g., about 50 ohms). See, e.g., FIGS. 2A and 2B. The one or more stored mappings of calibrated values include a DPD table at least between input values and gain values for DPD pre-compensation. In one or more specific examples, the gain values may be gain compensation values, and/or complex gain compensation values.

At an act 1404, a post-calibration process is executed. In one or more examples, the post-calibration process of act 1404 is part of the post-calibration process corresponding to method 800 of FIGS. 8A and 8B (i.e., act 804). The post-calibration process of act 1404 may include at least acts 1406 and 1408. At act 1406, a post-DPD calibration process is executed to generate an updated DPD table associated with the mismatched impedance. The updated DPD table is at least between input values and updated gain values for DPD pre-compensation associated with the mismatched impedance. In one or more examples, the post-DPD calibration process of act 1406 is executed at the outset of the overall post-calibration sequence or prior to the post-calibration process of act 804 of FIG. 8A.

At act 1408, at a threshold value, a DPD gain difference between a DPD gain of the DPD table and an updated DPD gain of the updated DPD table is determined. In one or more examples, the determination at act 1408 is performed at the end of or before the act 828 of method 800 in FIG. 8B. At an act 1410, a power backoff is applied in the control of the transmit output power of the RF signals at least partially based on the DPD gain difference.

In one or more examples, when the DPD profile is compressed, the system may utilize a specific power backoff. When the DPD profile is expanded, there is no need for a power backoff (e.g., it may be bypassed or not used). In one or more examples, the power backoff may be achieved by lowering the gain index of the VGA by a predetermined amount associated with the backoff (or alternatively, adjusted in the digital domain).

A specific, non-limiting example of a post-calibration procedure including a post-calibration process for an RF transmitter is now described. In this specific example, the RF transmitter including the RF transmitter front-end has been calibrated (i.e., factory calibrated) with respect to an antenna having a predetermined impedance of 50 ohms. The reference gain index Gi_{Ref} associated with the factory calibration is 82 (i.e., Gi_{Ref}=82), which is associated with a corresponding reference TSSI value T_{50Ω} and a corresponding reference output power value P_{50Ω}.

A user (e.g., designer, engineer, or technician) selects an antenna for use with the RF transmitter including the RF transmitter front-end. The selected antenna has a mismatched impedance different from the predetermined impedance of the RF transmitter front-end. In this specific example, the antenna has a mismatched impedance of about 33Ω.

In one or more examples, the user may check a datasheet including information associated with the selected antenna having the mismatched impedance of about 33 Ω (e.g., act 604 of FIG. 6). The information associated with the selected antenna may include the VSWR of the antenna. In one or more examples, the VSWR of an antenna may be calculated as

$$VSWR = \frac{1 + \vert Γ \vert}{1 - \vert Γ \vert} \\ or \\ VSWR = \frac{1 + \vert \frac{{Z}_{L} - {Z}_{c}}{{Z}_{L} + {Z}_{c}} \vert}{1 - \vert \frac{{Z}_{L} - {Z}_{c}}{{Z}_{L} + {Z}_{c}} \vert}$$

where Z_{c} is the characteristic impedance and Z_{L} is the load impedance. Accordingly, where Z_{C}=50Ω and Z_{L}=33Ω, the VSWR of the antenna is determined to be about 1.51. Assuming the load is purely resistive, then the angle of the reflection coefficient is zero degrees.

Given the above, the user identifies that the VSWR of the antenna is greater than 1.5 and less than 3 (i.e., 3≥1.51≥1.5) (e.g., “Yes” branch in act 604 of FIG. 6), and proceeds to connect the antenna to the RF transmitter front-end (e.g., act 606 of FIG. 6) for execution of the post-calibration process (e.g., act 608 of FIG. 6).

The post-calibration process may be the process described in relation to act 804 of method 800 of FIGS. 8A and 8B. At act 806 of FIG. 8A, a reference output power mismatch loss ΔP_{Loss} at the reference gain index Gi_{Ref} is determined at least partially based on a difference between the reference output power value P_{50Ω} and the projected mismatch loss output power value P′_{50Ω Proj} (i.e., ΔP_{Loss}=P_{50Ω}−P′_{50Ω Proj}). Here, ΔP_{Loss} is determined to be approximately 2.5 dB (i.e., ΔP_{Loss}=2.5 dB).

At act 814 of FIG. 8A, a first reference gain index difference ΔGi_{PI} associated with the predetermined impedance (i.e., ΔGi_{PI}=Gi_{Ref}−Gi′_{Ref}) is determined at least partially based on the reference output power mismatch loss ΔP_{Loss}. Here, the adjusted reference gain index Gi′_{Ref} that corresponds to a measured TSSI value (T_{VSWR>1}) that corresponds to the reference output power value is determined to be 92 (i.e., Gi′_{Ref}=92). Here, the first reference gain index difference ΔGi_{PI} that satisfies the reference output power mismatch loss ΔP_{Loss} of about 2.5 dB is determined to be ΔGi_{PI}=Gi_{Ref}−Gi′_{Ref}=82−92=−10.

Continuing at act 822 in FIG. 8B, a second reference gain index difference ΔGi_{MI} associated with the mismatched impedance (i.e., ΔGi_{MI}=Gi_{Ref}−G_{VSWR>1}) is determined as a predetermined function (e.g., the empirical function, a non-linear polynomial) of the first reference gain index difference ΔGi_{PI} associated with the predetermined impedance (i.e., ΔGi_{MI}=f(ΔGi_{PI})). In one or more examples, the predetermined function is the non-linear polynomial, the empirical function ΔGi_{MI}=round(−0.0108*(ΔGi_{PI})²−0.6300*(ΔGi_{PI})+3.1203). Here, where ΔGi_{PI}=−10, ΔGi_{MI}=round(−0.0108*(−10)²−0.6300*(−10)+3.1203)=8. That is, ΔGi_{MI}=8.

At act 824 of FIG. 8B, a new reference gain index G_{VSWR>1} associated with the mismatched impedance is determined at least partially based on the second reference gain index difference associated with the mismatched impedance. More particularly, G_{VSWR>1}=Gi_{Ref}−sign(ΔGi_{PI})*ΔGi_{MI}. Where Gi_{Ref}=82 and ΔGi_{MI}=8, G_{VSWR>1}=82−sign(ΔGi_{PI})*ΔGi_{MI}=82−(−8)=90.

At act 826 of FIG. 8B, a new TSSI value is measured at the new reference gain index, and the TSSI vector is modified. Previously, the factory-calibrated reference gain index Gi_{Ref} of 82 was used as a base reference to establish gain indexes Gi=Gi_{Ref}+[−b, −a, 0, +a, +b] at which TSSI measurements were made, for example, gain indexes Gi=Gi_{Ref}+[−16, −8, 0, +8, +16]=[82−16, 82−8, 82, 82+8, 82+16]=[66, 74, 82, 90, 98]. Now, the new reference gain index G_{VSWR>1} of 90 is used as the base reference to establish the gain indexes at which TSSI measurements are made, for example, Gi=G_{VSWR>1}+[−16, −8, 0, +8, +16]=[90−16, 90−8, 90, 90+8, 90+16]=[74, 82, 90, 98, 106]. As the new reference gain index and newly-measured TSSI values are used in association with the previously-calibrated output power values, the mismatched load will again see the transmit output power as defined in the factory.

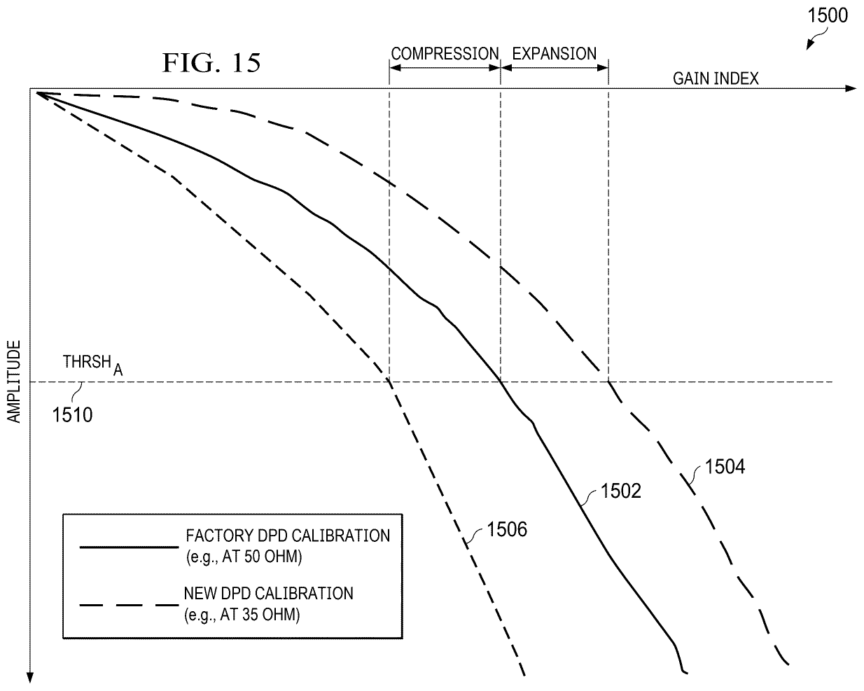

Lastly, in the specific example, the power backoff is calculated based on the new DPD profiles. FIG. 15 is a plot 1500 including a curve 1502 of signal input (amplitude) versus gain (or gain index) for the RF PA, according to one or more examples. Curve 1502 is indicated as the factory DPD calibration at 50 ohms. Curve 1502 characterizes the RF PA before DPD is applied, revealing a non-linear decrease in the output power at higher input power levels. With respect to the specific example, a curve 1504 is indicated as the new DPD calibration at 33 ohms. Curve 1504 reveals that the DPD is expanded with the mismatched load, and therefore there is a DPD gain difference “expansion” associated with the mismatched load. Due to such expansion, the method in relation to the specific example does not provide any power backoff for the DPD change (i.e., the power backoff=0). On the other hand, a curve 1506 relates to an alternative DPD calibration at an alternative load impedance. Curve 1506 reveals that the DPD is compressed in relation to the alternative load impedance, and therefore there is a DPD gain difference “compression” associated with the mismatched load. Due to such compression, the method would provide a specific power backoff for the DPD change based on the gain difference.

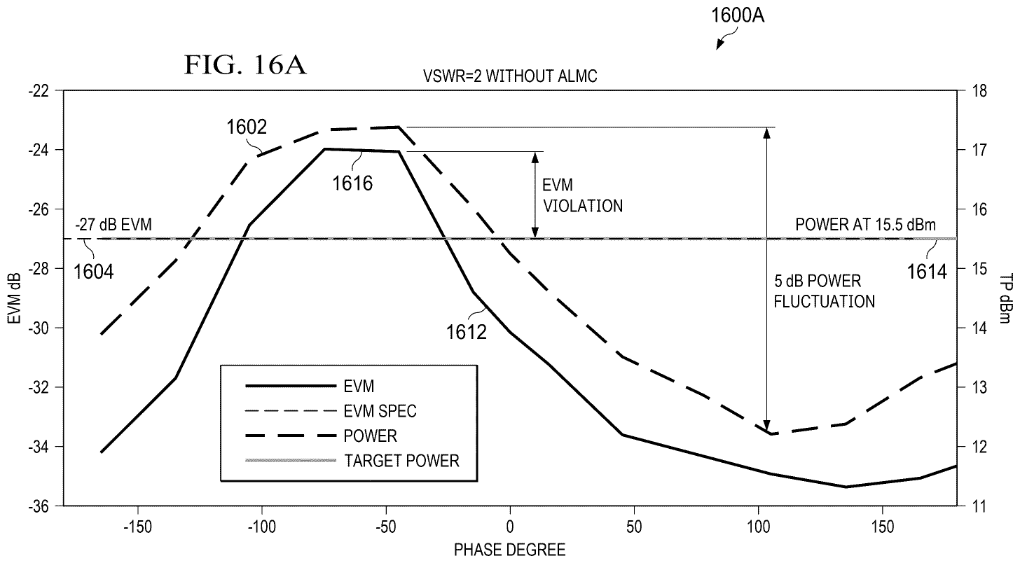

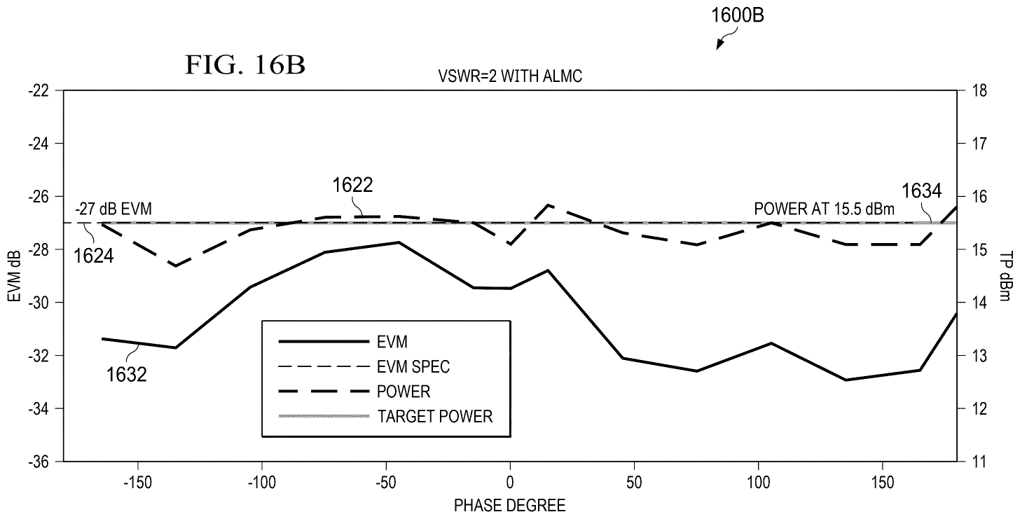

As previously discussed, the post-calibration process is to provide the RF signal transmitting apparatus with a stable transmit output power and an acceptable EVM, to facilitate adequate or within-specification RF signal transmission. In an illustrative example of FIGS. 16A and 16B, the output power and error vector magnitude (EVM) characteristic of a system having an antenna VSWR of about two (2) are examined with respect to all possible load phases (from −180 degrees to +180 degrees).

FIG. 16A is a plot 1600A of example measurements of output power and EVM versus load phase for RF transmission, with the antenna VSWR of two (2), without use of the post-calibration process of the disclosure. Plot 1600A indicates an output power curve 1602 relative to a target output power reference 1604, and an EVM curve 1612 relative to an EVM specification reference 1614. Here, what is depicted is a power fluctuation of more than 5 dB using the mismatched antenna. EVM clearly violates the specification at certain load phases (e.g., refer to a region 1616 of EVM curve 1612). As both the power fluctuation and EVM clearly exceed the specification at certain load phases, they would not be acceptable.

FIG. 16B is a plot 1600B of example measurements of output power and EVM versus load phase for RF transmission, with the antenna VSWR of two (2), with use of the post-calibration process of the disclosure. Plot 1600B indicates an output power curve 1632 relative to a target output power reference 1634, and an EVM curve 1622 relative to an EVM specification reference 1624. As is apparent, power held at the target with a small residual ripple and within specification EVM levels are exhibited by the RF signal transmitting apparatus when deployed. Here, output power is restrained to the specified target power of 15.5 dBm, and EVM is restrained to better than specification requirements.

FIG. 17 is a flowchart of a method 1700 of processing to operate an RF signal transmitting apparatus, which includes a post-calibration process, according to one or more examples of the disclosure. In one or more examples, method 1700 is performed at one or more processors adapted to control and monitor transmit output power of RF signals transmitted through an RF transmitter front-end.

At an act 1702, one or more calibration processes are executed to generate and store one or more mappings of calibrated values associated with RF transmission from the RF transmitter front-end at least initially with respect to a load having a predetermined impedance (e.g., about 50 ohms). The one or more calibration processes may be one or more factory calibration processes. The one or more stored mappings are at least between gain indexes, TSSI values, and output power values of the RF transmitter front-end. The one or more stored mappings include a reference gain index and a reference output power value associated with the reference gain index.

At an act 1704, a post-calibration process for the RF transmitter front-end is executed with respect to an antenna having a mismatched impedance different from the predetermined impedance. In the post-calibration process, at an act 1706, a new reference gain index associated with the mismatched impedance is determined at least partially based on a reference gain index difference that satisfies a reference output power mismatch loss at the reference gain index. At an act 1708, new TSSI values are measured at respective new gain indexes adjusted at least partially based on the new reference gain index. At an act 1710, the one or more stored mappings are updated to include the new reference gain index and the new TSSI values for association with the output power values. Here, after act 1710, the power values may be retained, and any DPD/backoff adjustments may be handled in the separate DPD branch (acts 1406-1410 of FIG. 14), which may slightly reduce the target power when compression is detected.

At an act 1712, the transmit output power of the RF signals transmitted from the RF transmitter front-end via the antenna having the mismatched impedance is controlled and monitored at least partially based on the one or more stored mappings updated with the new reference gain index and the new TSSI values for association with the output power values.

In one or more examples, the one or more calibration processes at act 1702 include connection of the RF transmitter front-end to external test measurement equipment adapted to measure the transmit output power of the RF signal transmission at the load. In one or more examples, the post-calibration process at act 1704 excludes connection of the RF transmitter front-end to external test measurement equipment adapted to measure the transmit output power of the RF signal transmission. In one or more examples, the one or more stored mappings updated with the new reference gain index and the new TSSI values from the post-calibration process retain the output power values of the one or more stored mappings. In one or more examples, the stored power values are retained, and if DPD indicates compression beyond tolerance, a runtime power backoff may be applied, overriding the nominal target to satisfy linearity/EVM limit.

In one or more examples, the post-calibration process in act 1704 is executed with respect to the antenna having the mismatched impedance associated with a VSWR of between about 1.5 and 3. In one or more examples, a determination regarding whether to initiate or invoke the post-calibration process in act 1704 based on the VSWR of the antenna is made at least in part by a user of an RF transmitter including the RF transmitter front-end.

In one or more examples, method 1700 of FIG. 17 may include the acts of method 1400 of FIG. 14 for post-DPD calibration (e.g., recalibration). For example, the one or more stored mappings of calibrated values of method 1700 of FIG. 17 may include a DPD table at least between input values and gain values for DPD pre-compensation. In the post-calibration process, prior to act 1706 (i.e., at the beginning or outset of the post-calibration process), a DPD calibration process is executed for the RF transmitter front-end with respect to the antenna having the mismatched impedance to generate an updated DPD table associated with the mismatched impedance. Subsequently (e.g., even after act 1710), at a threshold value, a DPD gain difference between a DPD gain of the DPD table and an updated DPD gain of the updated DPD table is determined. In act 1712, a power backoff is applied in the control of the transmit output power of the RF signals at least partially based on the DPD gain difference.

In one or more examples, the reference output power mismatch loss at the reference gain index may be determined in act 1706 based on measuring a mismatch loss TSSI value at the reference gain index; determining, from the one or more stored mappings based on the mismatch loss TSSI value, a projected mismatch loss output power value at the reference gain index; and determining the reference output power mismatch loss at least partially based on a difference between the reference power value and the projected mismatch loss output power value.

In one or more examples, the reference gain index difference associated with the predetermined impedance may be determined in act 1706 based on measuring one or more TSSI values at respective one or more gain indexes to determine an adjusted reference gain index that corresponds to a measured TSSI value that corresponds to the reference output power value (via the factory TP_{50Ω} mapping); and determining the reference gain index difference associated with the predetermined impedance at least partially based on a difference between the reference gain index and the adjusted reference gain index.

In one or more examples, the new reference gain index associated with the mismatched impedance is determined in act 1706 based on determining a reference gain index difference associated with the mismatched impedance at least partially as a predetermined function of the reference gain index difference associated with the predetermined impedance. In one or more examples, the predetermined function of the reference gain index difference associated with the predetermined impedance comprises an empirical function. The empirical function may be empirically derived at least partially based on operation of the RF transmitter front-end. In one or more examples, the empirical function comprises a non-linear function.

Thus, according to one or more examples, a method executed at one or more processors controls and monitors transmit output power using stored factory mappings (e.g., Gain-TSSI-Power) generated at a predetermined impedance (e.g., about 50Ω), including a reference gain index and associated reference power. With a mismatched-impedance antenna, a post-calibration process determines a new reference gain index based on a gain index difference that satisfies a reference power mismatch at the original reference gain index; measures new TSSI values at gain indices around the new reference gain index; and updates the stored mappings (while retaining the power targets) to maintain the desired transmit power under the mismatch load (optionally without external test equipment).

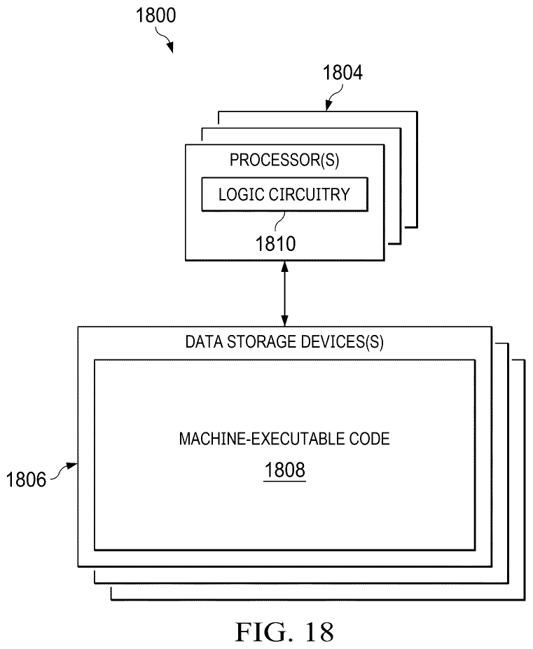

It will be appreciated by those of ordinary skill in the art that functional elements of examples disclosed herein (e.g., functions, operations, acts, processes, and/or methods) may be implemented in any suitable hardware, software, firmware, or combinations thereof. FIG. 18 illustrates non-limiting examples of implementations of functional elements disclosed herein. In some examples, some or all portions of the functional elements disclosed herein may be performed by hardware specially implemented for carrying out the functional elements.

FIG. 18 is a block diagram of circuitry 1800 that, in some examples, may be used to implement various functions, operations, acts, processes, and/or methods disclosed herein. Circuitry 1800 includes one or more processors 1804 (sometimes referred to herein as “processors 1804”) operably coupled to one or more data storage devices (sometimes referred to herein as “storage 1806”). Storage 1806 includes machine-executable code 1808 stored thereon and processors 1804 include a logic circuitry 1810. Machine-executable code 1808 includes information describing functional elements that may be implemented by (e.g., performed by) logic circuitry 1810. Logic circuitry 1810 is adapted to implement (e.g., perform) the functional elements described by machine-executable code 1808. Circuitry 1800, when executing the functional elements described by machine-executable code 1808, should be considered as special purpose hardware for carrying out functional elements disclosed herein. In some examples, processors 1804 may perform the functional elements described by machine-executable code 1808 sequentially, concurrently (e.g., on one or more different hardware platforms), or in one or more parallel process streams.

When implemented by logic circuitry 1810 of processors 1804, machine-executable code 1808 adapts processors 1804 to perform operations of examples disclosed herein. For example, machine-executable code 1808 may be to adapt processors 1804 to perform at least a portion or a totality of methods or processes described herein (e.g., act 610 of FIG. 6, method 800 of FIGS. 8A and 8B, method 1400 of FIG. 14, a combination of method 800 of FIGS. 8A and 8B and method 1400 of FIG. 14, and method 1700 of FIG. 17).

Processors 1804 may include a general purpose processor, a special purpose processor, a central processing unit (CPU), an MCU, a programmable logic controller (PLC), a DSP, an ASIC, a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer executes functional elements corresponding to machine-executable code 1808 (e.g., software code, firmware code, hardware descriptions) related to examples of the disclosure. It is noted that a general-purpose processor (may also be referred to herein as a host processor or simply a host) may be a microprocessor, but in the alternative, processors 1804 may include any conventional processor, controller, microcontroller, or state machine. Processors 1804 may also be implemented as a combination of computing devices, such as a combination of a DSP and a microprocessor, a plurality of microprocessors, one or more microprocessors in conjunction with a DSP core, or any other such configuration. For ALMC, these processors may execute the post-calibration routine (method 800 and/or method 1700) and optional DPD recalibration routine (method 1400 of FIG. 14).

In some examples, storage 1806 includes volatile data storage (e.g., random-access memory (RAM)), non-volatile data storage (e.g., Flash memory, a hard disc drive, a solid-state drive, erasable programmable read-only memory (EPROM), etc.). In some examples, processors 1804 and storage 1806 may be implemented into a single device (e.g., a semiconductor device product, an SoC, etc.). In some examples, processors 1804 and storage 1806 may be implemented into separate devices.

In some examples, machine-executable code 1808 may include computer-readable instructions (e.g., software code, firmware code). By way of non-limiting example, the computer-readable instructions may be stored by storage 1806, accessed directly by processors 1804, and executed by processors 1804 using at least logic circuitry 1810. Also by way of non-limiting example, the computer-readable instructions may be stored on storage 1806, transferred to a memory device (not shown) for execution, and executed by processors 1804 using at least logic circuitry 1810. Accordingly, in some examples, logic circuitry 1810 may include electrically configurable (programmable) logic.

In some examples, machine-executable code 1808 may describe hardware (e.g., circuitry) to be implemented in logic circuitry 1810 to perform the functional elements. This hardware may be described at any of a variety of levels of abstraction, from low-level transistor layouts to high-level description languages. At a high-level of abstraction, a hardware description language (HDL) such as an IEEE Standard hardware description language (HDL) may be used. By way of non-limiting examples, Verilog, System Verilog, and/or hardware description language (HDL) may be used to implement very large-scale integration (VLSI).

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of logic circuitry 1810 may be described in RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some examples, machine-executable code 1808 may include an HDL, an RTL, a GL description, a mask-level description, other hardware description, or any combination thereof.

In examples where machine-executable code 1808 includes a hardware description (at any level of abstraction), a system (not shown but including storage 1806) may be used to implement the hardware description described by machine-executable code 1808. By way of non-limiting example, processors 1804 may include a programmable logic device (e.g., an FPGA or a complex programmable logic device (CPLD)) and logic circuitry 1810 may be electrically controlled to implement circuitry corresponding to the hardware description within logic circuitry 1810. Also by way of non-limiting example, logic circuitry 1810 may include hard-wired logic manufactured by a manufacturing system (not shown, but including storage 1806) according to the hardware description of machine-executable code 1808.

Regardless of whether machine-executable code 1808 includes computer-readable instructions or a hardware description, logic circuitry 1810 is adapted to perform the functional elements described by machine-executable code 1808 when implementing the functional elements of machine-executable code 1808. It is noted that although a hardware description may not directly describe functional elements, a hardware description indirectly describes functional elements that the hardware elements described by the hardware description are capable of performing.

As used in the present disclosure, the terms “module” or “component” may refer to specific hardware implementations to perform the actions of the module or component and/or software objects or software routines that may be stored on and/or executed by general purpose hardware (e.g., computer-readable media, processing devices, etc.) of the computing system. In some examples, the different components, modules, engines, and services described in the present disclosure may be implemented as objects or processes that execute on the computing system (e.g., as separate threads). While some of the systems and methods described in the present disclosure are generally described as being implemented in software (stored on and/or executed by general-purpose hardware), specific hardware implementations or a combination of software and specific hardware implementations are also possible and contemplated.

As used in the present disclosure, the term “combination” with reference to a plurality of elements may include a combination of all the elements or any of various different subcombinations of some of the elements. For example, the phrase “A, B, C, D, or combinations thereof” may refer to any one of A, B, C, or D; the combination of each of A, B, C, and D; and any subcombination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to examples containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.,” or “one or more of A, B, and C, etc.,” is used, in general such a construction is intended to include A alone, B alone, C alone, A and B together, A and C together, B and C together, or A, B, and C together, etc.

Any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

A non-exhaustive, non-limiting list of examples follows. Not each of the examples listed below is explicitly and individually indicated as being combinable with all others of the examples listed below and examples discussed above. It is intended, however, that these examples are combinable with all other examples unless it would be apparent to one of ordinary skill in the art that the examples are not combinable.

Example 1: A method comprising: at one or more processors adapted to control and monitor transmit output power of radio frequency (RF) signals transmitted through an RF transmitter front-end at least partially based on one or more stored mappings of calibrated values, the one or more stored mappings of calibrated values associated with RF transmission from the RF transmitter front-end at least initially with respect to a load having a predetermined impedance, the one or more stored mappings at least between gain indexes, transmit signal strength indicator (TSSI) values, and output power values, the one or more stored mappings including a reference gain index and a reference output power value associated with the reference gain index, executing a post-calibration process for the RF transmitter front-end with respect to an antenna having a mismatched impedance different from the predetermined impedance, the post-calibration process comprising: determining a new reference gain index associated with the mismatched impedance at least partially based on a reference gain index difference that satisfies a reference output power mismatch loss at the reference gain index; measuring new TSSI values at respective new gain indexes adjusted at least partially based on the new reference gain index; and updating the one or more stored mappings to include the new reference gain index and the new TSSI values for association with the output power values.

Example 2: The method according to Example 1, comprising: at the one or more processors, controlling and monitoring the transmit output power of the RF signals transmitted from the RF transmitter front-end via the antenna having the mismatched impedance at least partially based on the one or more stored mappings updated with the new reference gain index and the new TSSI values for association with the output power values.

Example 3: The method according to Examples 1 and 2, wherein the one or more stored mappings updated with the new reference gain index and the new TSSI values for association with the output power values increase transmission efficiency and/or reduce distortion with respect to the RF signals transmitted from the RF transmitter front-end via the antenna having the mismatched impedance.

Example 4: The method according to any of Examples 1 to 3, wherein the one or more stored mappings updated with the new reference gain index and the new TSSI values retain the output power values of the one or more stored mappings.

Example 5: The method according to any of Examples 1 to 4, wherein the one or more stored mappings of calibrated values include a digital pre-distortion (DPD) table at least between input values and gain values for DPD pre-compensation, and executing the post-calibration process comprises: performing a post-DPD calibration process for the RF transmitter front-end with respect to the antenna having the mismatched impedance to generate an updated DPD table associated with the mismatched impedance; determining, at a threshold value, a DPD gain difference between a DPD gain of the DPD table and an updated DPD gain of the updated DPD table; and applying a power backoff in the control of the transmit output power at least partially based on the DPD gain difference.

Example 6: The method according to any of Examples 1 to 5, wherein the post-calibration process is executed with respect to the antenna having the mismatched impedance associated with a voltage standing wave ratio (VSWR) of between about 1.5 and 3.

Example 7: The method according to any of Examples 1 to 6, wherein determining the reference output power mismatch loss at the reference gain index comprises: measuring a mismatch loss TSSI value at the reference gain index; determining, from the one or stored mappings based on the mismatch loss TSSI value, a projected mismatch loss output power value at the reference gain index; and determining the reference output power mismatch loss at least partially based on a difference between the reference power value and the projected mismatch loss output power value.

Example 8: The method according to any of Examples 1 to 7, wherein determining the reference gain index difference associated with the predetermined impedance comprises: measuring one or more TSSI values at respective one or more gain indexes to determine an adjusted reference gain index that corresponds to a measured TSSI value that corresponds to the reference output power value; and determining the reference gain index difference associated with the predetermined impedance at least partially based on a difference between the reference gain index and the adjusted reference gain index.

Example 9: The method according to any of Examples 1 to 8, wherein the new reference gain index associated with the mismatched impedance is further determined as a predetermined function of the reference gain index difference associated with the predetermined impedance.

Example 10: The method according to any of Examples 1 to 9, wherein the predetermined function of the reference gain index difference associated with the predetermined impedance comprises an empirical function, the empirical function being empirically derived at least partially based on operation of the RF transmitter front-end.

Example 11: The method according to any of Examples 1 to 10, wherein: at the one or more processors, prior to the post-calibration process, executing one or more calibration processes to generate the one or more stored mappings between the gain indexes, the TSSI values, and the output power values associated with the RF signal transmission from the RF transmitter front-end to the load having the predetermined impedance.

Example 12: The method according to any of Examples 1 to 11, wherein: the one or more calibration processes include connection of the RF transmitter front-end to external test measurement equipment adapted to measure the transmit output power of the RF signal transmission at the load; and the post-calibration process excludes connection of the RF transmitter front-end to external test measurement equipment adapted to measure the transmit output power of the RF signal transmission.

Example 13: An apparatus comprising: a radio frequency (RF) transmitter front-end; memory adapted to store one or more mappings of calibrated values, the one or more stored mappings of calibrated values associated with RF transmission from the RF transmitter front-end at least initially with respect to a load having a predetermined impedance, the one or more stored mappings at least between gain indexes, transmit signal strength indicator (TSSI) values, and output power values, the one or more stored mappings including a reference gain index and a reference output power value associated with the reference gain index; and one or more processors to: execute a post-calibration process for the RF transmitter front-end with respect to an antenna having a mismatched impedance different from the predetermined impedance, the post-calibration process to: determine a new reference gain index associated with the mismatched impedance at least partially based on a reference gain index difference that satisfies a reference output power mismatch loss at the reference gain index; obtain measurements of new TSSI values at respective new gain indexes adjusted at least partially based on the new reference gain index; and update the one or more stored mappings to include the new reference gain index and the new TSSI values for association with the output power values.

Example 14: The apparatus according to Example 13, wherein: the one or more processors to: control and monitor the transmit output power of RF signals transmitted from the RF transmitter front-end via the antenna having the mismatched impedance at least partially based on the one or more stored mappings updated with the new reference gain index and the new TSSI values for association with the output power values.

Example 15: The apparatus according to Examples 13 and 14, wherein the one or more stored mappings of calibrated values include a digital pre-distortion (DPD) table at least between input values and gain values for DPD pre-compensation, and wherein: the one or more processors are to execute the post-calibration process including to: perform a post-DPD calibration process for the RF transmitter front-end with respect to the antenna having the mismatched impedance to generate an updated DPD table associated with the mismatched impedance; determine, at a threshold value, a DPD gain difference between a DPD gain of the DPD table and an updated DPD gain of the updated DPD table; and apply a power backoff in the control of the transmit output power at least partially based on the DPD gain difference.

Example 16: The apparatus according to any of Examples 13 to 15, comprising: the RF transmitter front-end including: a variable RF gain amplifier; an RF power amplifier (RF PA), the RF PA including an input coupled to an output from the variable RF gain amplifier; an impedance matching circuitry having the predetermined impedance, the impedance matching circuitry including an input coupled to an output from the RF PA, the impedance matching circuitry having an output for coupling with the antenna having the mismatched impedance; and a TSSI detector, the TSSI detector including an input coupled to the output from the RF PA.

Example 17: The apparatus according to any of Examples 13 to 16, wherein the one or more stored mappings updated with the new reference gain index and the new TSSI values for association with the output power values increase transmission efficiency and/or reduce distortion with respect to the RF signals transmitted from the RF transmitter front-end via the antenna having the mismatched impedance.

Example 18: The apparatus according to any of Examples 13 to 17, wherein the post-calibration process is executed with respect to the antenna having the mismatched impedance associated with a voltage standing wave ratio (VSWR) between a predetermined range of values.

Example 19: The apparatus according to any of Examples 13 to 18, wherein determining the reference output power mismatch loss at the reference gain index comprises: measure a mismatch loss TSSI value at the reference gain index; determine, from the one or stored mappings based on the mismatch loss TSSI value, a projected mismatch loss output power value at the reference gain index; and determine the reference output power mismatch loss at least partially based on a difference between the reference power value and the projected mismatch loss output power value.

Example 20: The apparatus according to any of Examples 13 to 19, wherein determining the reference gain index difference associated with the predetermined impedance comprises: measure one or more TSSI values at respective one or more gain indexes to determine an adjusted reference gain index that corresponds to a measured TSSI value that corresponds to the reference output power value; and determine the reference gain index difference associated with the predetermined impedance at least partially based on a difference between the reference gain index and the adjusted reference gain index.

Example 21: The apparatus according to any of Examples 13 to 20, wherein the new reference gain index associated with the mismatched impedance is determined as a predetermined function of the reference gain index difference associated with the predetermined impedance.

Example 22: A non-transitory processor-readable medium that stores processor-executable instructions that, when executed by one or more processors of an RF signal transmitting apparatus, cause the one or more processors to perform operations to: maintain access to one or more stored mappings of calibrated values in memory, the one or more stored mappings of calibrated values associated with RF transmission from an RF transmitter front-end of the RF signal transmitting apparatus at least initially with respect to a load having a predetermined impedance, the one or more stored mappings at least between gain indexes, transmit signal strength indicator (TSSI) values, and output power values, the one or more stored mappings including a reference gain index and a reference output power value associated with the reference gain index; execute a post-calibration process for the RF transmitter front-end with respect to an antenna having a mismatched impedance different from the predetermined impedance, the post-calibration process to: determine a new reference gain index associated with the mismatched impedance at least partially based on a reference gain index difference that satisfies a reference output power mismatch loss at the reference gain index; obtain measurements of new TSSI values at respective new gain indexes adjusted at least partially based on the new reference gain index; and update the one or more stored mappings to include the new reference gain index and the new TSSI values for association with the output power values.

Example 23: The non-transitory processor-readable medium according to Example 22, wherein the one or more processors are to perform further operations to: control and monitor transmit output power of RF signals transmitted from the RF transmitter front-end via the antenna having the mismatched impedance at least partially based on the one or more stored mappings updated with the new reference gain index and the new TSSI values for association with the output power values.

Example 24: The non-transitory processor-readable medium according to Examples 22 and 23, wherein the one or more stored mappings of calibrated values include a digital pre-distortion (DPD) table at least between input values and gain values for DPD pre-compensation, and the one or more processors are to perform further operations to: perform a post-DPD calibration process for the RF transmitter front-end with respect to the antenna having the mismatched impedance to generate an updated DPD table associated with the mismatched impedance; determine, at a threshold value, a DPD gain difference between a DPD gain of the DPD table and an updated DPD gain of the updated DPD table; and apply a power backoff in the control of the transmit output power at least partially based on the DPD gain difference.

Example 25: An apparatus comprising: a radio frequency (RF) transmitter front-end including: a variable RF gain amplifier; an RF power amplifier (RF PA), the RF PA including an input coupled to an output from the variable RF gain amplifier; an impedance matching circuitry having a predetermined impedance, the impedance matching circuitry including an input coupled to an output from the RF PA, the impedance matching circuitry having an output for coupling with an antenna; and a peak detector, the peak detector including an input coupled to the output from the RF PA, the peak detector used to detect transmit signal strength indicator (TSSI) values; memory adapted to store one or more mappings of calibrated values, the one or more stored mappings of calibrated values associated with RF transmission from the RF transmitter front-end at least initially with respect to a load having the predetermined impedance, the one or more stored mappings at least between gain indexes, TSSI values, and output power values of the RF transmitter front-end, the one or more stored mappings including a reference gain index and a reference output power value associated with the reference gain index; and one or more processors to: execute a post-calibration process for the RF transmitter front-end with respect to an antenna having a mismatched impedance different from the predetermined impedance, the post-calibration process to: determine a new reference gain index associated with the mismatched impedance at least partially based on a reference gain index difference that satisfies a reference output power mismatch loss at the reference gain index; obtain measurements of new TSSI values at respective new gain indexes adjusted at least partially based on the new reference gain index; update the one or more stored mappings to include the new reference gain index and the new TSSI values for association with the output power values; and control and monitor the transmit output power of the RF signals transmitted from the RF transmitter front-end via the antenna having the mismatched impedance at least partially based on the one or more stored mappings updated with the new reference gain index and the new TSSI values for association with the output power values.

While the present disclosure has been described herein with respect to certain illustrated examples, those of ordinary skill in the art will recognize and appreciate that the present disclosure is not so limited. Rather, many additions, deletions, and modifications to the illustrated and described examples may be made without departing from the scope of the invention as hereinafter claimed along with their legal equivalents. In addition, features from one example may be combined with features of another example while still being encompassed within the scope of the invention as contemplated by the inventor.

What is claimed is:

1. A method comprising:
at one or more processors adapted to control and monitor transmit output power of radio frequency (RF) signals transmitted through an RF transmitter front-end at least partially based on one or more stored mappings of calibrated values, the one or more stored mappings of calibrated values associated with RF transmission from the RF transmitter front-end at least initially with respect to a load having a predetermined impedance, the one or more stored mappings at least between gain indexes, transmit signal strength indicator (TSSI) values, and output power values, the one or more stored mappings including a reference gain index and a reference output power value associated with the reference gain index,
executing a post-calibration process for the RF transmitter front-end with respect to an antenna having a mismatched impedance different from the predetermined impedance, the post-calibration process comprising:
determining a new reference gain index associated with the mismatched impedance at least partially based on a reference gain index difference that satisfies a reference output power mismatch loss at the reference gain index;
measuring new TSSI values at respective new gain indexes adjusted at least partially based on the new reference gain index; and
updating the one or more stored mappings to include the new reference gain index and the new TSSI values for association with the output power values.

2. The method of claim 1, comprising:
at the one or more processors,
controlling and monitoring the transmit output power of the RF signals transmitted from the RF transmitter front-end via the antenna having the mismatched impedance at least partially based on the one or more stored mappings updated with the new reference gain index and the new TSSI values for association with the output power values.

3. The method of claim 2, wherein the one or more stored mappings updated with the new reference gain index and the new TSSI values for association with the output power values increase transmission efficiency and/or reduce distortion with respect to the RF signals transmitted from the RF transmitter front-end via the antenna having the mismatched impedance.

4. The method of claim 2, wherein the one or more stored mappings updated with the new reference gain index and the new TSSI values retain the output power values of the one or more stored mappings.

5. The method of claim 2, wherein the one or more stored mappings of calibrated values include a digital pre-distortion (DPD) table at least between input values and gain values for DPD pre-compensation, and executing the post-calibration process comprises:
performing a post-DPD calibration process for the RF transmitter front-end with respect to the antenna having the mismatched impedance to generate an updated DPD table associated with the mismatched impedance;
determining, at a threshold value, a DPD gain difference between a DPD gain of the DPD table and an updated DPD gain of the updated DPD table; and
applying a power backoff in the control of the transmit output power at least partially based on the DPD gain difference.

6. The method of claim 1, wherein the post-calibration process is executed with respect to the antenna having the mismatched impedance associated with a voltage standing wave ratio (VSWR) of between about 1.5 and 3.

7. The method of claim 1, wherein determining the reference output power mismatch loss at the reference gain index comprises:
measuring a mismatch loss TSSI value at the reference gain index;
determining, from the one or stored mappings based on the mismatch loss TSSI value, a projected mismatch loss output power value at the reference gain index; and
determining the reference output power mismatch loss at least partially based on a difference between the reference power value and the projected mismatch loss output power value.

8. The method of claim 1, wherein determining the reference gain index difference associated with the predetermined impedance comprises:
measuring one or more TSSI values at respective one or more gain indexes to determine an adjusted reference gain index that corresponds to a measured TSSI value that corresponds to the reference output power value; and
determining the reference gain index difference associated with the predetermined impedance at least partially based on a difference between the reference gain index and the adjusted reference gain index.

9. The method of claim 1, wherein the new reference gain index associated with the mismatched impedance is further determined as a predetermined function of the reference gain index difference associated with the predetermined impedance.

10. The method of claim 9, wherein the predetermined function of the reference gain index difference associated with the predetermined impedance comprises an empirical function, the empirical function being empirically derived at least partially based on operation of the RF transmitter front-end.

11. The method of claim 1, wherein:
at the one or more processors,
prior to the post-calibration process, executing one or more calibration processes to generate the one or more stored mappings between the gain indexes, the TSSI values, and the output power values associated with the RF signal transmission from the RF transmitter front-end to the load having the predetermined impedance.

12. The method of claim 11, wherein:
the one or more calibration processes include connection of the RF transmitter front-end to external test measurement equipment adapted to measure the transmit output power of the RF signal transmission at the load; and
the post-calibration process excludes connection of the RF transmitter front-end to external test measurement equipment adapted to measure the transmit output power of the RF signal transmission.

13. An apparatus comprising:
a radio frequency (RF) transmitter front-end;
memory adapted to store one or more mappings of calibrated values, the one or more stored mappings of calibrated values associated with RF transmission from the RF transmitter front-end at least initially with respect to a load having a predetermined impedance, the one or more stored mappings at least between gain indexes, transmit signal strength indicator (TSSI) values, and output power values, the one or more stored mappings including a reference gain index and a reference output power value associated with the reference gain index; and
one or more processors to:
execute a post-calibration process for the RF transmitter front-end with respect to an antenna having a mismatched impedance different from the predetermined impedance, the post-calibration process to:
determine a new reference gain index associated with the mismatched impedance at least partially based on a reference gain index difference that satisfies a reference output power mismatch loss at the reference gain index;
obtain measurements of new TSSI values at respective new gain indexes adjusted at least partially based on the new reference gain index; and
update the one or more stored mappings to include the new reference gain index and the new TSSI values for association with the output power values.

14. The apparatus of claim 13, wherein:
the one or more processors to:
control and monitor the transmit output power of RF signals transmitted from the RF transmitter front-end via the antenna having the mismatched impedance at least partially based on the one or more stored mappings updated with the new reference gain index and the new TSSI values for association with the output power values.

15. The apparatus of claim 14, wherein the one or more stored mappings of calibrated values include a digital pre-distortion (DPD) table at least between input values and gain values for DPD pre-compensation, and wherein:
the one or more processors are to execute the post-calibration process including to:
perform a post-DPD calibration process for the RF transmitter front-end with respect to the antenna having the mismatched impedance to generate an updated DPD table associated with the mismatched impedance;
determine, at a threshold value, a DPD gain difference between a DPD gain of the DPD table and an updated DPD gain of the updated DPD table; and
apply a power backoff in the control of the transmit output power at least partially based on the DPD gain difference.

16. The apparatus of claim 14, comprising:
the RF transmitter front-end including:
a variable RF gain amplifier;
an RF power amplifier (RF PA), the RF PA including an input coupled to an output from the variable RF gain amplifier;
an impedance matching circuitry to exhibit the predetermined impedance at an output, the impedance matching circuitry including an input coupled to an output from the RF PA, the impedance matching circuitry having the output for coupling with the antenna having the mismatched impedance; and
a TSSI detector, the TSSI detector including an input coupled to the output from the RF PA.

17. The apparatus of claim 16, wherein the one or more stored mappings updated with the new reference gain index and the new TSSI values for association with the output power values increase transmission efficiency and/or reduce distortion with respect to the RF signals transmitted from the RF transmitter front-end via the antenna having the mismatched impedance.

18. The apparatus of claim 13, wherein the post-calibration process is executed with respect to the antenna having the mismatched impedance associated with a voltage standing wave ratio (VSWR) of between a predetermined range of values.

19. The apparatus of claim 13, wherein determining the reference output power mismatch loss at the reference gain index comprises:
measure a mismatch loss TSSI value at the reference gain index;
determine, from the one or stored mappings based on the mismatch loss TSSI value, a projected mismatch loss output power value at the reference gain index; and
determine the reference output power mismatch loss at least partially based on a difference between the reference power value and the projected mismatch loss output power value.

20. The apparatus of claim 13, wherein determining the reference gain index difference associated with the predetermined impedance comprises:
measure one or more TSSI values at respective one or more gain indexes to determine an adjusted reference gain index that corresponds to a measured TSSI value that corresponds to the reference output power value; and
determine the reference gain index difference associated with the predetermined impedance at least partially based on a difference between the reference gain index and the adjusted reference gain index.

21. The apparatus of claim 13, wherein the new reference gain index associated with the mismatched impedance is determined as a predetermined function of the reference gain index difference associated with the predetermined impedance.

22. A non-transitory processor-readable medium that stores processor-executable instructions that, when executed by one or more processors of an RF signal transmitting apparatus, cause the one or more processors to perform operations to:
maintain access to one or more stored mappings of calibrated values in memory, the one or more stored mappings of calibrated values associated with RF transmission from an RF transmitter front-end of the RF signal transmitting apparatus at least initially with respect to a load having a predetermined impedance, the one or more stored mappings at least between gain indexes, transmit signal strength indicator (TSSI) values, and output power values, the one or more stored mappings including a reference gain index and a reference output power value associated with the reference gain index;
execute a post-calibration process for the RF transmitter front-end with respect to an antenna having a mismatched impedance different from the predetermined impedance, the post-calibration process to:
determine a new reference gain index associated with the mismatched impedance at least partially based on a reference gain index difference that satisfies a reference output power mismatch loss at the reference gain index;
obtain measurements of new TSSI values at respective new gain indexes adjusted at least partially based on the new reference gain index; and
update the one or more stored mappings to include the new reference gain index and the new TSSI values for association with the output power values.

23. The non-transitory processor-readable medium of claim 22, wherein the one or more processors are to perform further operations to:
control and monitor transmit output power of RF signals transmitted from the RF transmitter front-end via the antenna having the mismatched impedance at least partially based on the one or more stored mappings updated with the new reference gain index and the new TSSI values for association with the output power values.

24. The non-transitory processor-readable medium of claim 22, wherein the one or more stored mappings of calibrated values include a digital pre-distortion (DPD) table at least between input values and gain values for DPD pre-compensation, and the one or more processors are to perform further operations to:
perform a post-DPD calibration process for the RF transmitter front-end with respect to the antenna having the mismatched impedance to generate an updated DPD table associated with the mismatched impedance;
determine, at a threshold value, a DPD gain difference between a DPD gain of the DPD table and an updated DPD gain of the updated DPD table; and
apply a power backoff in the control of the transmit output power at least partially based on the DPD gain difference.

25. An apparatus comprising:
a radio frequency (RF) transmitter front-end including:
a variable RF gain amplifier;
an RF power amplifier (RF PA), the RF PA including an input coupled to an output from the variable RF gain amplifier;
an impedance matching circuitry having a predetermined impedance, the impedance matching circuitry including an input coupled to an output from the RF PA, the impedance matching circuitry having an output for coupling with an antenna; and
a transmit signal strength indicator (TSSI) detector, the TSSI detector including an input coupled to the output from the RF PA;
memory adapted to store one or more mappings of calibrated values, the one or more stored mappings of calibrated values associated with RF transmission from the RF transmitter front-end at least initially with respect to a load having the predetermined impedance, the one or more stored mappings at least between gain indexes, TSSI values, and output power values of the RF transmitter front-end, the one or more stored mappings including a reference gain index and a reference output power value associated with the reference gain index; and
one or more processors to:
execute a post-calibration process for the RF transmitter front-end with respect to an antenna having a mismatched impedance different from the predetermined impedance, the post-calibration process to:
determine a new reference gain index associated with the mismatched impedance at least partially based on a reference gain index difference that satisfies a reference output power mismatch loss at the reference gain index;
obtain measurements of new TSSI values at respective new gain indexes adjusted at least partially based on the new reference gain index;
update the one or more stored mappings to include the new reference gain index and the new TSSI values for association with the output power values; and
control and monitor the transmit output power of the RF signals transmitted from the RF transmitter front-end via the antenna having the mismatched impedance at least partially based on the one or more stored mappings updated with the new reference gain index and the new TSSI values for association with the output power values.
